(19) United States
(12) Patent Application Publication
(10) Pub. No.: US 2022/0182412 A1
(43) Pub. Date: Jun. 9, 2022

(54) SYSTEMS AND METHODS OF EVALUATING PROBE ATTRIBUTES FOR SECURING A NETWORK

(71) Applicant: CACI, Inc. - Federal, Arlington, VA (US)

(72) Inventor: John A. BORAK, Glen Ridge, NJ (US)

(21) Appl. No.: 17/585,752

(22) Filed: Jan. 27, 2022

Related U.S. Application Data
(63) Continuation-in-part of application No. 17/557,115, filed on Dec. 21, 2021.
Application No. 17/557,115 is a continuation-in-part of application No. 17/460,696, filed on Aug. 30, 2021.
(60) Provisional application No. 63/074,688, filed on Sep. 4, 2020.

(51) Int. Cl. H04L 9/40; G06N 3/08

(52) U.S. Cl. CPC H04L 63/1491; G06N 3/08; H04L 63/20; H04L 63/1416

(57) ABSTRACT

The present application describes a method for evaluating probes. One step of the method includes configuring a client with a service to lure a probe associated with traffic flowing via an encrypted pathway to a node on a network. Another step of the method includes monitoring activity of the probe on the network and an interaction between the probe and the service on the node. Yet another step of the method includes determining, via a trained predictive machine learning model, in real-time whether the activity or the interaction exceeds a confidence threshold indicating a threat to the network. A further step of the method includes tagging the probe based upon the determination. Yet even a further step of the method includes updating a security policy of the network in view of the tagged probe.

### CROSS-REFERENCE TO RELATED APPLICATIONS

This application is a continuation-in-part of U.S. Non-provisional application Ser. No. 17/557,115 filed Dec. 21, 2021, which is a continuation-in-part of U.S. Non-provisional application Ser. No. 17/460,696 filed Aug. 30, 2021, which claims priority to U.S. Provisional Application No. 63/074,688 filed Sep. 4, 2020, the contents of which are all incorporated by reference in their entireties herein.

### FIELD

This application is generally directed to systems and methods of evaluating probe attributes for securing a network.

### BACKGROUND

Probes are commonly used by hackers to detect vulnerabilities in software and hardware residing on a network. Once the vulnerabilities have been detected, probes may infect the software and hardware with a virus. Once infected, the virus may spread to other software and hardware on the network causing intermittent or complete interruptions in communication. The probes may also be used to install a backdoor configured for hackers to enter at will and obtain confidential information residing on the network.

Modern cybersecurity tools collect vast amounts of security data to effectively perform security-related computing tasks including though not limited to incident detection, vulnerability management, and security orchestration. For example, security data related to what probes, bots and/or attackers are doing in, across, and against cloud computing environments can be gathered by recording telemetry associated with connections and incoming attacks. In turn, these can be used to identify techniques and procedures used by such probes, bots and/or attackers.

Generating actionable security data to take proactive and time-sensitive security action(s) requires efficient and timely analysis of the collected security data. However, existing machine learning tools are prone to noise in a dataset resulting in unwanted variation in clustering results. This instability is undesirable when analyzing collected security data to vulnerabilities and potentially malicious activity. conditions, and the like.

What may be desired in the art is an improved system, method and/or software application employing predictive machine learning (ML) to accurately monitor, detect and assess probes, bots and/or attackers considered threats to the network.

What may also be desired in the art is a cyber security platform employing data of malicious probes found on a network to improve security against subsequent malicious probes.

### SUMMARY

The foregoing needs are met, to a great extent, by the disclosed apparatus, system and method for providing network diversification and secure communications.

One aspect of the application is directed to a method including plural steps for evaluating a probe entering a network. One step of the method may include configuring a client with a service to lure a probe associated with traffic flowing via an encrypted pathway to a node on the network. Another step of the method may include monitoring activity of the probe on the network and an interaction between the probe and the service on the node. Yet another step of the method may include determining, via a trained predictive machine learning model, in real-time whether the activity or the interaction exceeds a confidence threshold indicating a threat to the network. A further step of the method may include tagging the probe based upon the determination. Yet a further step of the method may include updating a security policy of the network in view of the tagged probe.

Another aspect of the application may be directed to a system including a non-transitory memory with instructions for evaluating a probe entering a network and a processor configured to execute the instructions. One of the instructions may include configuring a client with a service to lure a probe associated with traffic flowing via an encrypted pathway to the client on a network. Another one of the instructions may include monitoring an interaction between the probe and the service. Yet another one of the instructions may include determining, via a trained predictive machine learning model, in real-time whether the interaction exceeds a confidence threshold indicating a threat to the network. A further one of the instructions may include tagging the probe based upon the determination. Yet a further one of the instructions may include predicting, based on the tagged probe, a likelihood of another probe threatening security on the network.

A further aspect of the application may be directed to a method including plural steps to develop a training data set for evaluating probes in a network. One of the steps may include receiving, at a machine learning model, a first subset of a raw data set including labels for identifying a probe likely to pose a security threat to the network. Another one of the steps may include training, via the machine learning model, in view of the first, labelled subset of the raw data set. A further one of the steps may include receiving a second, unlabeled subset of the raw data set. A further one of the steps may include automatically labeling, via the machine learning model and the labeled first subset, one or more datum in the second subset based on the probe exceeding a confidence threshold. Even a further one of the steps may include outputting a training data set based upon the second subset for training the machine learning model or another machine learning model.

There has thus been outlined, rather broadly, certain embodiments in order that the detailed description thereof herein may be better understood, and in order that the present contribution to the art may be better appreciated. There are, of course, additional embodiments of the invention that will be described below and which will form the subject matter of the claims appended hereto.

### BRIEF DESCRIPTION OF THE DRAWINGS

In order to facilitate a fuller understanding of the invention, reference is now made to the accompanying drawings, in which like elements are referenced with like numerals. These drawings should not be construed as limiting the invention and intended only to be illustrative.

FIG. 1A illustrates an exemplary hardware/software architecture according to an aspect of the application.

FIG. 1B illustrates an exemplary computing system according to an aspect of the application.

FIG. 2 illustrates an exemplary system level view of the architecture according to an aspect of the application.

FIG. 3 illustrates traffic and encrypted pathway diversification functionality of the architecture in FIG. 2 according to an aspect of the application.

FIG. 4 illustrates an administrative user interface (UI) of the architecture in FIG. 2 according to an aspect of the application.

FIG. 5A illustrates another administrative UI depicting the creation of an encrypted pathway for supporting traffic flow to a destination according to an aspect of the application.

FIG. 5B illustrates yet another administrative UI depicting a first hop of the created encrypted pathway according to an aspect of the application.

FIG. 6 illustrates yet another administrative UI of the architecture according to an aspect of the application.

FIG. 7 illustrates a further administrative UI for monitoring the interface status of plural VPNs according to an aspect of the application.

FIG. 8 illustrates yet even a further administrative UI indicating testing of the created VPNs according to an aspect of the application.

FIG. 9 illustrates an architecture of a network communicating with a satellite network via one or more encrypted pathways according to an aspect of the application.

FIG. 10A illustrates a flow depicting functionality to obfuscate network traffic in a multi-hop network according to an aspect of the application.

FIG. 10B illustrates another flow depicting functionality to obfuscate network traffic in a multi-hop network according to an aspect of the application.

FIG. 11 illustrates even another flow depicting functionality to obfuscate network traffic in a multi-hop network according to another aspect of the application.

FIG. 12 illustrates a threat detection architecture in a multi-hop network.

FIG. 13 illustrates a threat monitoring cycle for determining a probe from a third party in a multi-hop network.

FIG. 14 illustrates a ML model for determining a probe seeking to obtain information about a multi-hop network according to an aspect of the application.

FIG. 15 illustrates an administrative UI for determining, flagging and updating policies regarding probes sent from third parties according to an aspect of the application.

FIG. 16A illustrates a flow depicting functionality for determining a probe according to an aspect of the application.

FIG. 16B illustrates another flow depicting functionality for determining a probe according to an aspect of the application.

FIG. 16C illustrates a further flow depicting functionality for determining a probe according to an aspect of the application.

FIG. 17 illustrates an architecture where traffic travelling over encrypted pathways between a home network and a satellite network is redirected to travel between another satellite network and the home network according to an aspect of the application.

FIG. 18 illustrates a ML model that may help develop training data and may deploy a trained ML model for evaluating real-time information associated with an imminent event to occur at the satellite network according to an aspect of the application.

FIG. 19 illustrates an exemplary user interface of a second satellite network managing its own traffic and transferred traffic from the first satellite network according to an aspect of the application.

FIG. 20A illustrates a flow depicting functionality for determining an imminent event at a satellite network via a trained ML model according to an aspect of the application.

FIG. 20B illustrates a flow depicting functionality for training a ML model to learn about an imminent event from raw data and automatically label additional raw data of an imminent event at a satellite network to produce training data according to an aspect of the application.

FIG. 21 illustrates an architecture for detecting a malicious probe on a network according to an aspect of the application.

FIG. 22 illustrates a ML model to develop training data, a ML model trained with the training data, and a trained ML model deployed to evaluate malicious probes in the network according to an aspect of the application.

FIG. 23 illustrates an exemplary user interface of managing malicious and non-malicious probes in a network according to an aspect of the application.

FIG. 24A illustrates a flow depicting functionality for determining a malicious probe via a trained ML model according to an aspect of the application.

FIG. 24B illustrates a flow depicting functionality for training a ML model to determine a malicious probe according to an aspect of the application.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

In an aspect, it has been determined and exemplarily described in the application that the functionality at the gateway improves network diversification and security from third party probing and attacks. In one embodiment, complex networks may be presented on an administrator UI. The UI may be a simple representation that helps manage network traffic flowing through one or more encrypted pathways. The logical networks overlay outbound physical networks operated by ISPs. These logical networks are configured to be dynamic, e.g., constantly changing, and managed in the background. The logical networks employ encryption protocols such as for example, one or more of OpenVPN, IPsec, SSH, and Tor.

As will be described and supported in this application, logical networks including encryption protocols may be understood to be synonymous with the phrase encrypted pathways. Importantly, the encrypted pathways may include multiple hops. The multiple hops may have the capability of varying protocols and points of presence to obfuscate traffic on the network. The functionality makes it difficult, and thus cost prohibitive, for third parties to observe and trace browsing history to a particular client.

In one embodiment, the architecture may provide administrators with the ability only to configure protocols once. In other words, constant oversight of the protocols may be unnecessary. This results in a robust level of obfuscation for a large group of clients' identities and locations on the network.

In another embodiment, the architecture may provide the administrator or owner/operator of the smart gateway with options to collect spatial-temporal data from monitoring traffic flow. The options allow the administrator to collect data regarding certain types of traffic flow. For example, the administrator may wish to collect data of all HTTP and HTTPs traffic requests from clients versus other traffic types such as FTP. The options also allow the administrator to collect data regarding specific clients.

In yet another embodiment, the system architecture may include a cloud orchestration platform. The cloud orchestration platform provides programmatic creation and management of virtual machines across a variety of public and private cloud infrastructure. Moreover, the cloud orchestration platform may enable privacy-focused system design and development.

The cloud orchestration platform may offer uniform and simple mechanisms for dynamically creating infrastructure that hosts a variety of solutions. Exemplary solutions may include networks that provide secure and/or obfuscated transport. The solutions may include a dynamic infrastructure that is recreated and continuously moved across the Internet. The solutions also offer the ability to host independent applications or solutions.

### Computer Architecture

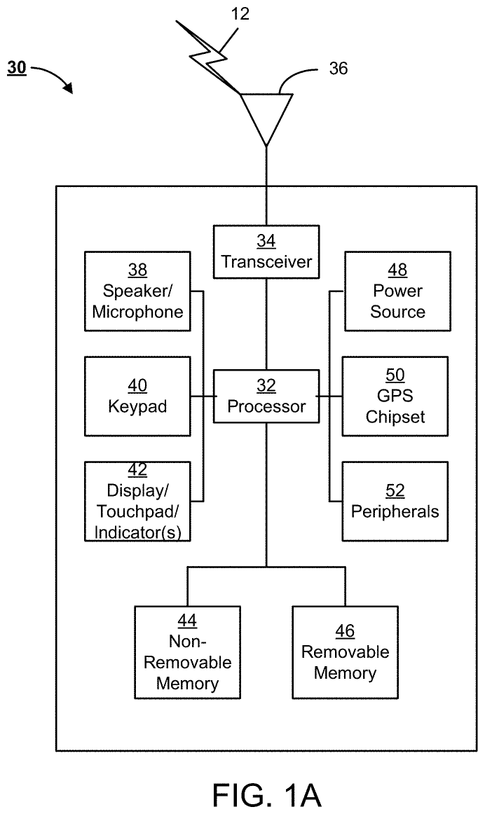

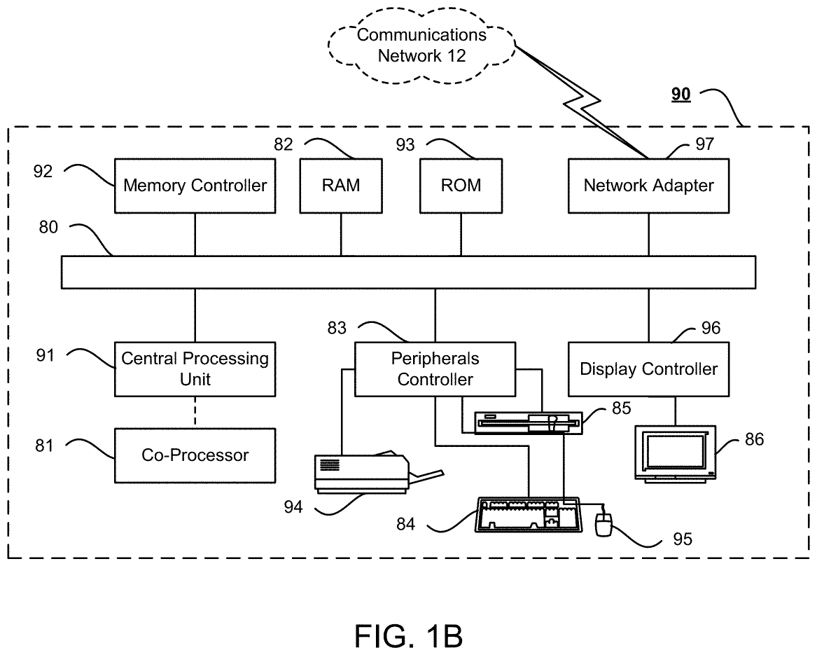

FIG. 1A is a block diagram of an exemplary hardware/software architecture of a node 30 of a network, such as clients, servers, or proxies, which may operate as a server, gateway, device, or other node in a network. The node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. The node 30 may include any sub-combination of the foregoing elements while remaining consistent with an embodiment.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node 30. For example, the processor 32 may perform signal coding, data processing, power control, input/output processing, and/or any other functionality that enables the node 30 to operate in a wireless or wired environment. The processor 32 may run application-layer programs (e.g., browsers) and/or radio-access-layer (RAN) programs and/or other communications programs. The processor 32 may also perform security operations, such as authentication, security key agreement, and/or cryptographic operations. The security operations may be performed, for example, at the access layer and/or application layer.

As shown in FIG. 1A, the processor 32 is coupled to its communication circuitry (e.g., transceiver 34 and transmit/receive element 36). The processor 32, through the execution of computer-executable instructions, may control the communication circuitry to cause the node 30 to communicate with other nodes via the network to which it is connected. While FIG. 1B depicts the processor 32 and the transceiver 34 as separate components, the processor 32 and the transceiver 34 may be integrated together in an electronic package or chip.

The transmit/receive element 36 may be configured to transmit signals to, or receive signals from, other nodes, including servers, gateways, wireless devices, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. The transmit/receive element 36 may be configured to transmit and/or receive any combination of wireless or wired signals.

In addition, although the transmit/receive element 36 is depicted in FIG. 1A as a single element, the node 30 may include any number of transmit/receive elements 36. More specifically, the node 30 may employ multiple-input and multiple-output (MIMO) technology. Thus, in an embodiment, the node 30 may include two or more transmit/receive elements 36 (e.g., multiple antennas) for transmitting and receiving wireless signals.

The transceiver 34 may be configured to modulate the signals to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as Universal Terrestrial Radio Access (UTRA) and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. The node 30 may acquire location information by way of any suitable location-determination method while remaining consistent with an embodiment.

The processor 32 may further be coupled to other peripherals 52, which may include one or more software and/or hardware modules that provide additional features, functionality, and/or wired or wireless connectivity. For example, the peripherals 52 may include various sensors such as an accelerometer, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, an Internet browser, and the like.

The node 30 may also be embodied in other apparatuses or devices. The node 30 may connect to other components, modules, or systems of such apparatuses or devices via one or more interconnect interfaces, such as an interconnect interface that may comprise one of the peripherals 52.

FIG. 1B is a block diagram of an exemplary computing system 90 that may be used to implement one or more nodes (e.g., clients, servers, or proxies) of a network, and which may operate as a server, gateway, device, or other node in a network. The computing system 90 may comprise a computer or server and may be controlled primarily by computer-readable instructions, which may be in the form of software, by whatever means such software is stored or accessed. Such computer-readable instructions may be executed within a processor, such as a central processing unit (CPU) 91, to cause the computing system 90 to effectuate various operations. In many known workstations, servers, and personal computers, the CPU 91 is implemented by a single-chip CPU called a microprocessor. In other machines, the CPU 91 may comprise multiple processors. A co-processor 81 is an optional processor, distinct from the CPU 91 that performs additional functions or assists the CPU 91.

In operation, the CPU 91 fetches, decodes, executes instructions, and transfers information to and from other resources via the computer's main data-transfer path, a system bus 80. Such a system bus 80 connects the components in the computing system 90 and defines the medium for data exchange. The system bus 80 typically includes data lines for sending data, address lines for sending addresses, and control lines for sending interrupts and for operating the system bus 80. An example of such a system bus 80 is the PCI (Peripheral Component Interconnect) bus.

Memories coupled to the system bus 80 include RAM 82 and ROM 93. Such memories include circuitry that allows information to be stored and retrieved. The ROM 93 generally contains stored data that cannot easily be modified. Data stored in the RAM 82 may be read or changed by the CPU 91 or other hardware devices. Access to the RAM 82 and/or the ROM 93 may be controlled by a memory controller 92. The memory controller 92 may provide an address translation function that translates virtual addresses into physical addresses as instructions are executed. The memory controller 92 may also provide a memory protection function that isolates processes within the system and isolates system processes from user processes. Thus, a program running in a first mode may access only memory mapped by its own process virtual address space. It cannot access memory within another process's virtual address space unless memory sharing between the processes has been set up.

In addition, the computing system 90 may contain a peripherals controller 83 responsible for communicating instructions from the CPU 91 to peripherals, such as a printer 94, a keyboard 84, a mouse 95, and a disk drive 85.

A display 86, which is controlled by a display controller 96, is used to display visual output generated by the computing system 90. Such visual output may include text, graphics, animated graphics, and video. The display 86 may be implemented with a CRT-based video display, an LCD-based flat-panel display, gas plasma-based flat-panel display, or a touch-panel. The display controller 96 includes electronic components required to generate a video signal that is sent to the display 86.

### Obfuscating Network Traffic

According to another aspect of the application, an architecture may secure and anonymize client traffic. Specifically, a smart gateway may obfuscate network traffic received from clients on a network intended for the world wide web, a satellite network, or a cloud server. Network traffic may be spatially and temporally diversified across numerous transport tunnels based on plural criteria.

The architecture may offer customized options for entities of all sizes to secure and privatize communications. In an exemplary embodiment, one or more network security client protocols running at the smart gateway is connected to a server. Namely, an encrypted pathway, e.g., tunnel, is established between the network security client protocols and a sever to encrypt data flowing therethrough. This presents the data as unreadable to anyone outside the encrypted pathway. Namely, the encrypted pathway hides the IP address and geo-location of the client and replaces it with another address.

The network security client protocols may include for example, one or more of OpenVPN, IPsec, SSH, and TOR, to encrypt network traffic. Upon receipt by the associated server, the data is decrypted and may subsequently be forwarded to a web server hosting a web page. Alternatively, the decrypted data may be sent to a cloud sever. In an exemplary embodiment and as envisaged in this application, any network security client protocols discussed above may be broadly described as a VPN client and the associated server receiving the encrypted data may be broadly described as a VPN server unless specifically limited to a particular protocol.

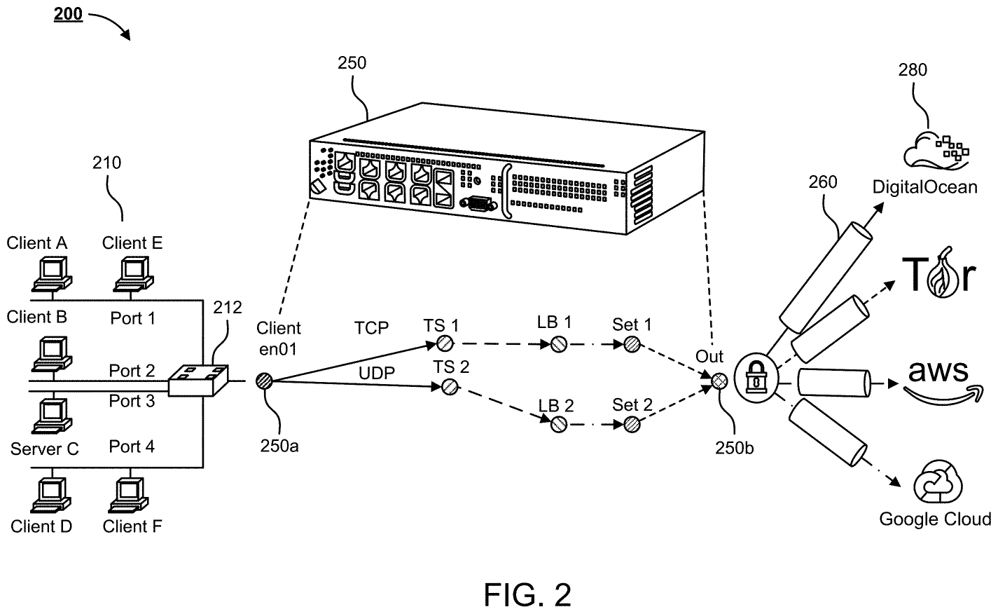

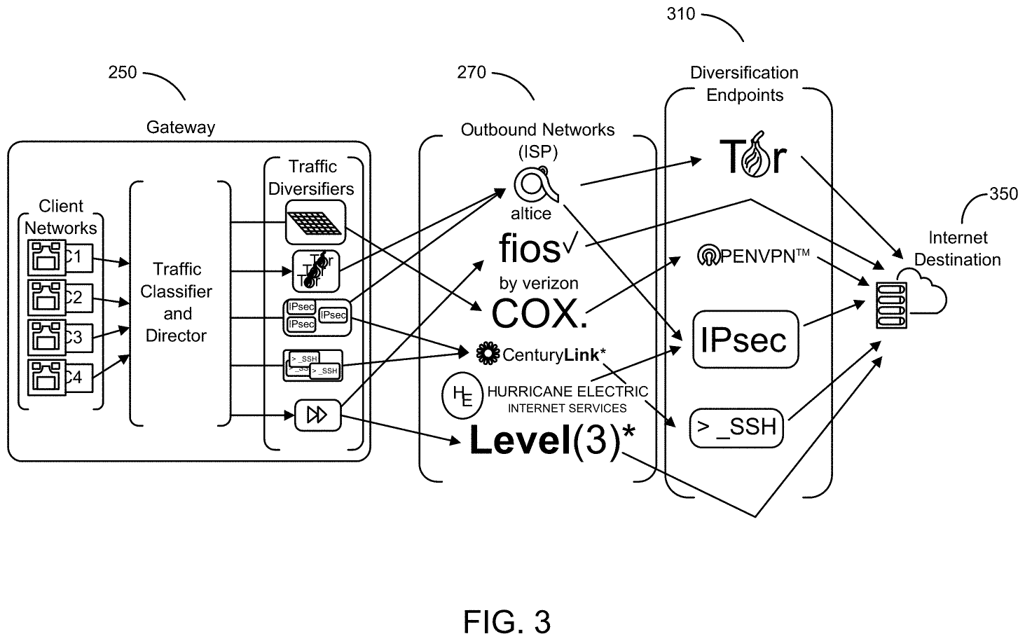

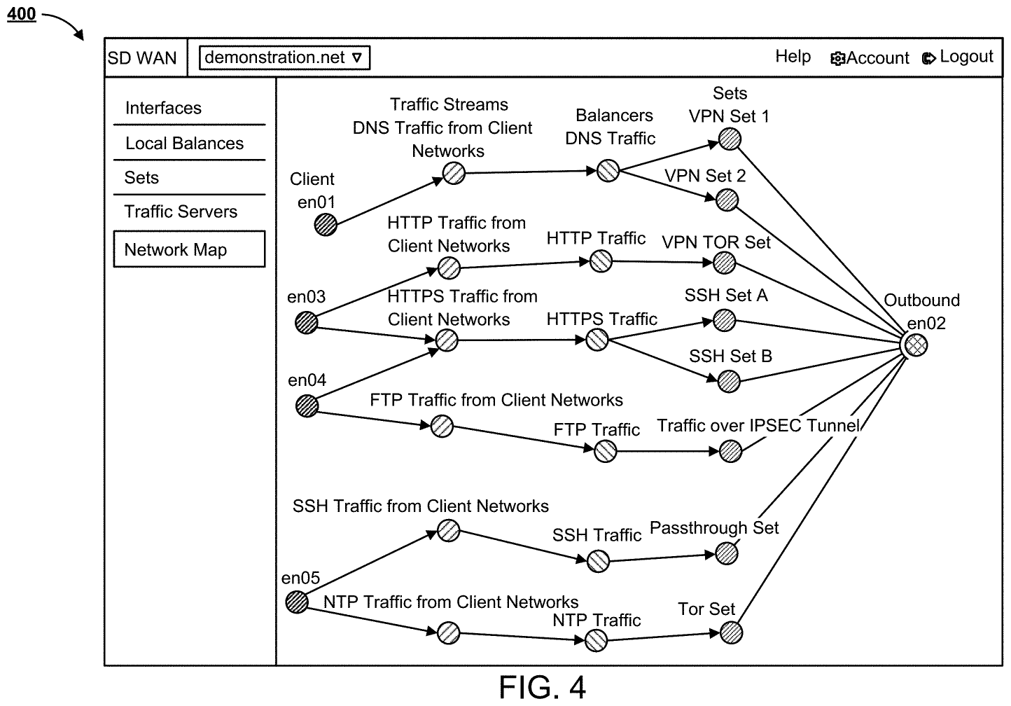

In an embodiment, FIG. 2 depicts a system architecture 200 including an network 210 connected to a smart gateway 250. The network includes plural clients connected via ports to a home or local router 212. Traffic from the home router 212 is received at an input 250a of the smart gateway 250. The obfuscation techniques and functionality occurring, or causing to occur remotely, at the smart gateway 250 will be discussed in more detail below with respect to FIGS. 3 and 4.

Obfuscated network traffic based on one or more security criteria exits an output 250b of the smart gateway 250 and is transported via one or more encrypted pathways to a destination. As shown in FIG. 2, the destination may include one or more cloud servers operated by a cloud service provider (CSP). The cloud servers may include one or more of DigitalOcean, Tor, AWS and Google Cloud.

In a further embodiment as depicted in FIG. 3, the functionality within the smart gateway 250 is described. Specifically, the smart gateway 250 operates as a traffic classifier and director of received traffic from one or more client networks. These client networks may be understood to represent components within the network 210 depicted in FIG. 2. Here, the client network illustrates four clients transmitting traffic to the smart gateway 250.

In an exemplary embodiment, the smart gateway 250 determines a protocol type and source IP address of the received traffic. For example, when a user requests a web page composed of resources from several different web servers (i.e., main content, advertising network content, content delivery network (CDN) content, cross-site resources, etc.), the request for each resource on these servers is made across different logical links. In other words, separate connections are made to each respective server with a different security protocol. To an observing webmaster, several different source locations (IP addresses) are utilized for loading the complete content of the web page.

Next, the network security protocol is configured and employed to support traffic based on a specific protocol type and/or source IP address. Specifically, traffic based on particular protocol types is classified and parsed. Traffic is then sent from the smart router 250 via the VPN server 310 through one or more connected physical networks 270, e.g., ISPs. In other words, each established physical network connection will have dynamically routed traffic travelling across logical links to a particular destination such as the Internet 350.

FIG. 4 illustrates a detailed schematic of how network traffic is sorted by the smart gateway according to an embodiment. In this exemplary embodiment, four clients—en01, en03, en04, en05—on the local network transmit traffic to the smart gateway represented by the furthest left group of circles.

Upon receiving traffic from the plural users/clients, the smart gateway determines and parses a protocol type of the received traffic from all clients as represented by the group of second most left circles. As shown the protocol type of the traffic may include but is not limited to DNS, HTTP, HTTPS, FTP, SSH and NTP. Specifically, traffic from en01 is entirely DNS traffic. Traffic from en03 includes HTTP and HTTPS traffic. Traffic from en04 include HTTPS and FTP traffic. Traffic from en05 include SSH and NTP traffic.

In an embodiment, the traffic may also be parsed by source IP address at the group of second most left circles. Additionally, at this group of second most left circles, the smart gateway evaluates whether the received traffic from at least two of the plural users/clients is associated with a particular protocol type. As depicted in FIG. 4, en03 and en04 share a common HTTPS protocol type. The smart gateway combines traffic associated with the common HTTPS.

Next, the smart gateway may perform a load balancing step. Specifically, the smart router assesses whether one or more security network protocol/servers, e.g., encrypted pathways, should support flow therethrough of the received traffic associated with the protocol type. And if more than one protocol/server is required, these servers are configured prior to exiting the smart gateway.

According to even another embodiment, each of the plural encrypted pathways for a specific protocol type may employ similar or different security network protocols. As illustrated in FIG. 4 by the group of third and fourth most left circles, DNS network traffic is split into VPN Set 1 and VPN Set 2 based on the amount of data being transmitted. Similarly, HTTPS network traffic is split into SSH Set A and SSH Set B based on the amount of data being transmitted. Meanwhile, HTTP network traffic originating from en03 is sent through a single VPN-Tor Set. FTP network Traffic originating at en04 is sent through an IPSEC Tunnel. SSH Traffic originating from en05 is sent through a Passthrough Set. Further, NTP traffic originating at en05 is sent through a Tor Set.

As further shown in FIG. 4, traffic associated with the protocol type may be transmitted from the smart gateway's exit 250b, e.g., outbound or otherwise en02, via the encrypted pathway to a particular destination. In an embodiment, the pathways may be configured to share or extend through separate physical interfaces. This may achieve controlled diversity and resiliency. The architecture may also be multi-homed. That is, the ISP may operate over cellular, fiber, copper, etc. and allow grouped pathways to be diversified across different physical communication mediums and ISPs. These configurations allow operators to coarsely and finely control spatial-temporal diversity.

As even further shown in FIG. 4, the encrypted pathway may ultimately send client traffic to a web server on the world wide web, i.e., Internet. Alternatively, the encrypted pathway may send client traffic to a cloud server connecting the home network to a satellite network with similar security credentials.

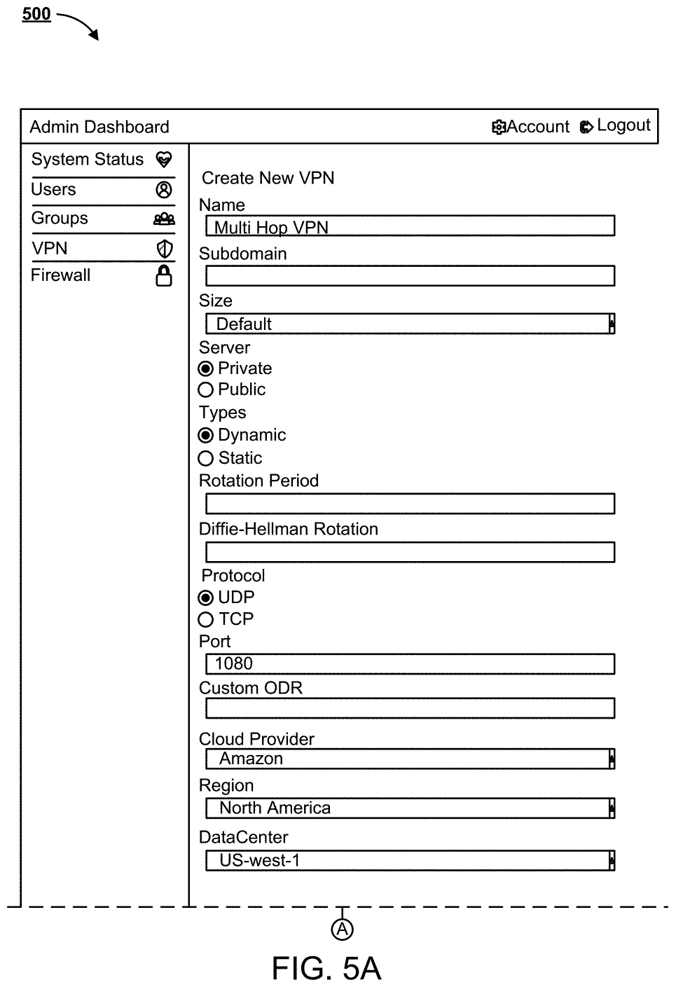

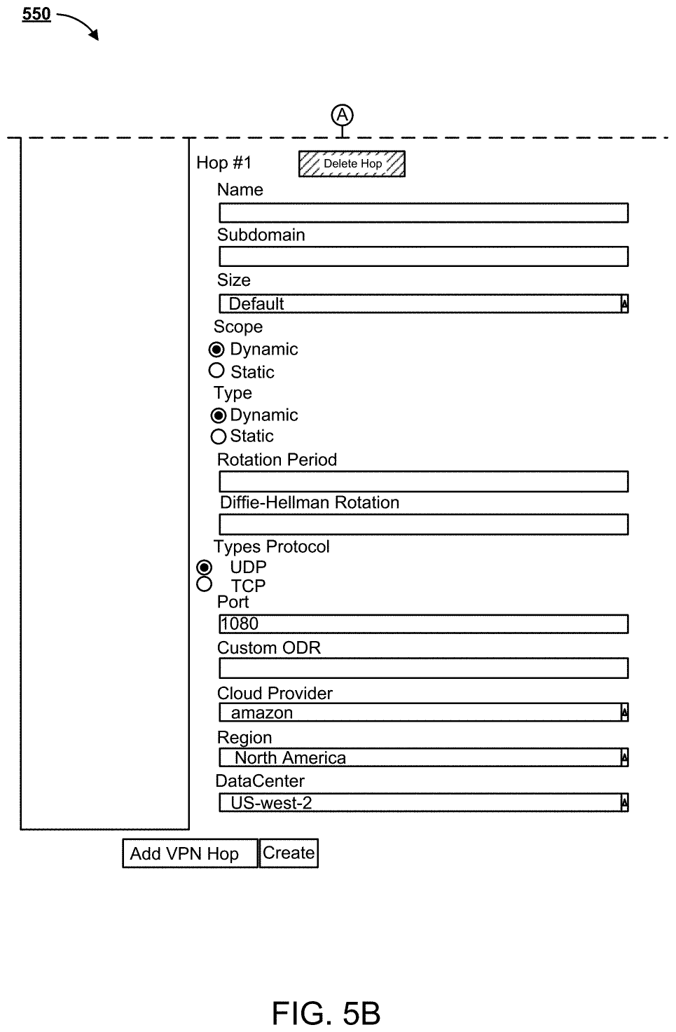

According to yet another embodiment as illustrated in FIG. 5A, an administrative dashboard on a UI 500 associated with the smart gateway is described. The right hand column of the UI illustrates plural options for an administrator to manage and evaluate the health of the network from the perspective of the smart gateway 250. Specially, the right hand column provides options to view System Status, Users, Groups, Encrypted Pathways, e.g., VPNs, and Firewalls. While the administrative dashboard indicates creation of a “New VPN,” this is merely exemplary and intended only to be one embodiment of all encrypted pathways discussed in this application. In other words, other encrypted pathways described above may also be created via the dashboard shown in the UI.

The specific UI depicted in FIG. 5A may be named “Create New VPN.” Different input boxes are provided for the administrator to populate information based on the specific demands of the network. The first input box allows the administrator to provide a name for the new encrypted pathway. The name provided in the first input box is “Multi-hop VPN.” The second input box allows an administrator to provide a Subdomain. The next input box in allows the administrator to select a size from one or more options. As shown, the size selected is “Default.”

The next option allows for the administrator to identify a scope of protection for the network. Namely, the encrypted pathway may run in either private or public mode. Private mode is the selected option in the UI. In an embodiment Private mode may be a default scope for a newly created encrypted pathway.

The next option displayed on the UI allows for the administrator to select a Type of encrypted pathway. The VPN may either be dynamic or static. And as shown in the UI, the new VPN has been selected to run in Dynamic mode. Dynamic mode maybe a default option when creating a newly encrypted pathway. Dynamic mode in the scope of the instant application may be understood to mean one or more criteria changes with respect to IP address, geography and cloud provider while network traffic is sent over the encrypted pathway.

Even another option displayed on the UI allows the administrator to determine a Rotation Period. This means the period at which one more criteria, such as IP address and geography, is changed can be customized. The UI also provides an option for the administrator to select Diffie-Hellman Rotation.

A further option displayed on the UI is to select a protocol. The protocol may either be UDP or TCP according to the particular embodiment. UDP may be a default prompt when creating a new encrypted pathway.

Yet a further option on the UI allows the administrator to select a port. As shown the port is manually inputted to be 1080. In some embodiments, this may be a default.

Yet even a further option on the UI allows the administrator to select a custom CIDR. This box is left blank in the particular embodiment.

As further shown in the UI, a cloud provider may be selected from one or more cloud providers. The cloud providers options may include but are not limited to AWS, Tor, Google, Azure Stack, and DigitalOcean. The cloud provider options may continuously be updated to keep up with new providers in the marketplace. As shown in the UI, the newly created pathway selected “Amazon” as its cloud provider.

Even a further option in the UI may be for selecting a region. Here, the region may be selected from a drop down box. As shown in FIG. 5A, North America was selected as the region. During rotation, the region may be changed to another region, such as for example, South America, Africa, Middle East, Europe, East Asia, South Asia, and Australia.

Still in even a further embodiment, the UI provides a drop down box to select a Data Center. As shown, the Data Center was selected to be US-West:1.

According to another embodiment, the UI 550 depicted in FIG. 5B may also include the ability to add one or more hops. Adding hops enhances network security by further obfuscating network traffic. Indeed, the hops may have dynamic functionality at least regarding IP address and geography. For example, each hop may employ a different security network protocol. It is also envisaged according to the instant application that each hop may include a different cloud provider. It is further envisaged according to the instant application that each hop may include a different geography or frequency.

As further shown in FIG. 5B, a prompt box option is provided to delete the hop if one is not necessary. The information for populating the hop is similar to the information for populating the VPN. That is, Hop #1 requires populating boxes associated with name, subdomain, size, scope, type, rotation, Differ-Hellman rotation, protocol, port, custom CIDR, cloud provider, region, and data center.

Further, two prompt boxes are provided at the bottom of the UI as depicted in FIG. 5B. One prompt box may be “Add VPN Hop” otherwise known to add an encrypted pathway. Another prompt box is “Create” which allows the administrator to add the encrypted pathway with or without one or more hops. As described above, the specific encrypted pathway is intended for a particular protocol type being operable and configured to support network traffic flowing therethrough to a destination.

In addition, the architecture shown in FIG. 5B integrates an Internet privacy solution based on a software platform that enables programmable creation and management of network security protocols. This capability, along with the diversified network routing behavior, creates constantly changing paths through the network and points of presence that can be automatically and dynamically scaled based on specific needs.

These form-factors enable gateway operators to take varying configuration approaches that leverage different instance types and respective deployment locations. Deployment configurations that integrate these various supported form-factors can be created to augment, and further obfuscate communications across the Internet. Such configurations can also be used to create a layered solution that is more resilient with regard to support, sustainment, and operations. The ability to integrate several deployments helps ensure mission readiness.

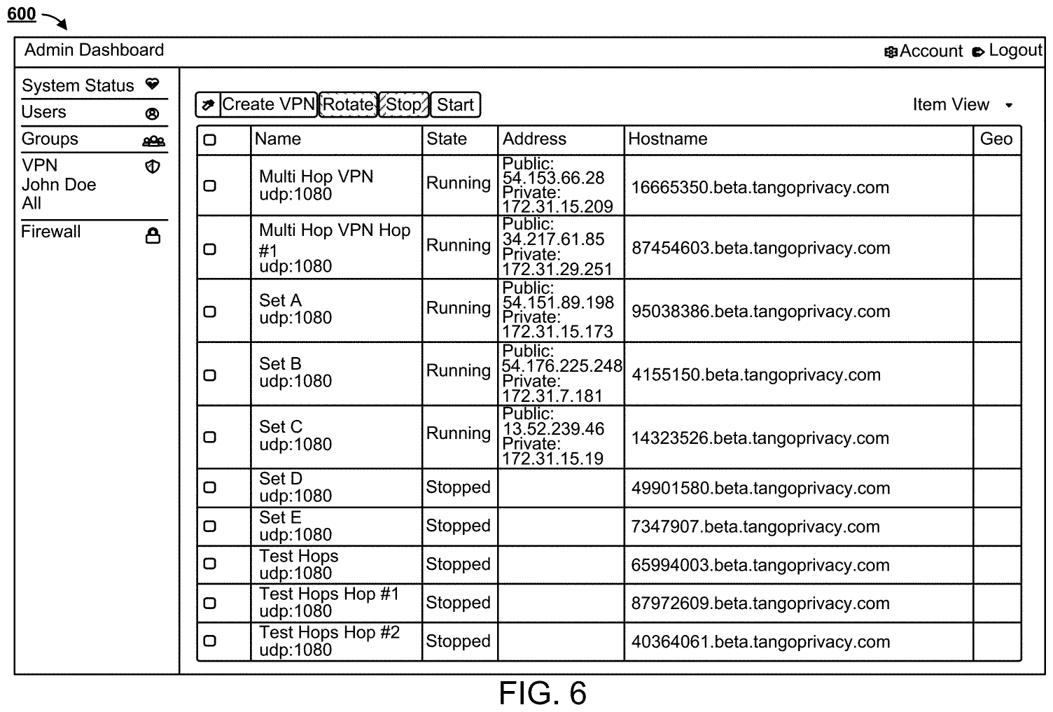

FIG. 6 illustrates an exemplary embodiment of another administrative dashboard UI 600 for managing encrypted pathways. Once one or more encrypted pathways, e.g., VPN servers as depicted, has been created, it will appear on the UI. As shown, there are plural encrypted pathways appearing in the UI in column format. The appearance of the plural encrypted pathways may be customized to present relevant information to the administrator and may be color coded.

As illustrated in the right-most column are names of the encrypted pathways. These include MultiHop TPN, Multi Hop VPN Hop #1, Set A, Set B, Set C, Set D, Set E, Test Hops, Test Hops Hop #1, Test Hops #2.

The next column over describes a state of the encrypted pathway. The next column over provides a state. The next column over provides a pathway address. The next column over provides a host name. The next column over provides Geography. Additional options for each encrypted pathway may also appear and may be customized by the user.

As further shown in FIG. 6, in the second most right column is a Running State of one or more of the encrypted pathways. Meanwhile, other encrypted pathways are in a Stopped state.

Regarding the address, the administrator may see both a public and private IP address for each of the encrypted pathways.

As further depicted in FIG. 6, located just above the encrypted pathway names, is one or more prompt boxes permitting the administrator to Create a VPN, e.g., FIGS. 5-5A, Rotate one or more VPNs, Stop service for one or more VPNs, and Start service for one or more VPNs. The option for rotation of VPN servers may be configured to rotate dynamically across varied cloud providers, geographies and frequencies. In a typical configuration, tens or hundreds of VPNs may be employed. The number of VPNs may be scaled up according to the needs of the administrators. The VPNs may be rotated hourly or customized according to a preset frequency.

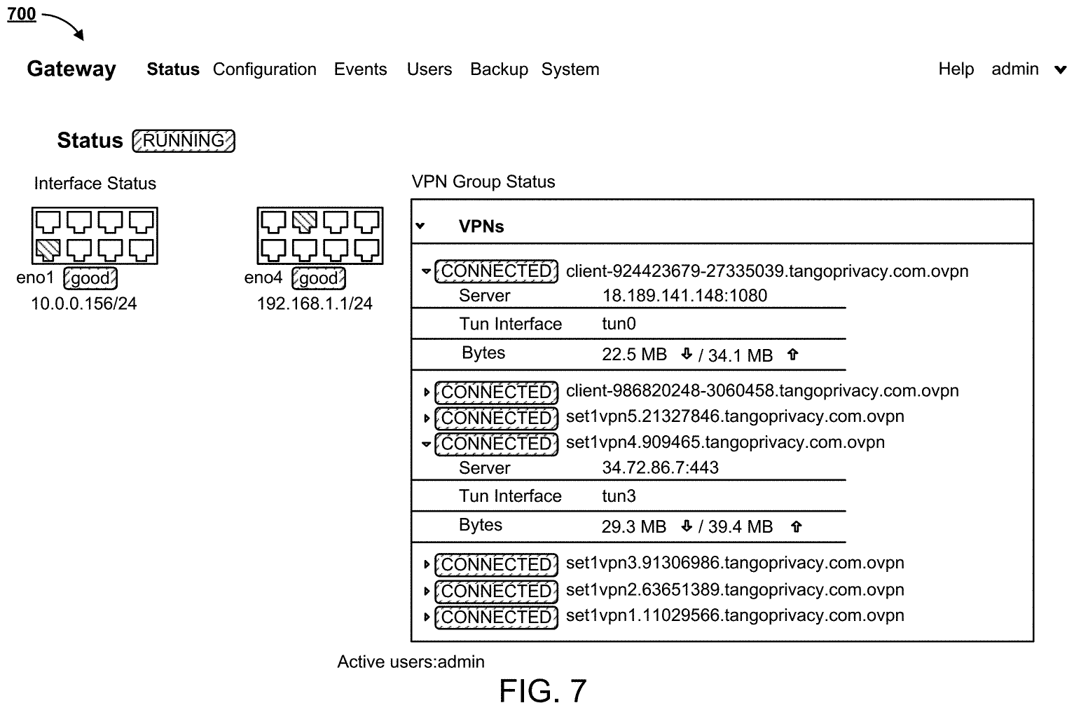

According to another embodiment, FIG. 7 illustrates an administrative dashboard UI 700 displaying a status of the VPN servers. As shown, en01 and en04 are connected with an indication of “good.” This means the VPN is operating in good health.

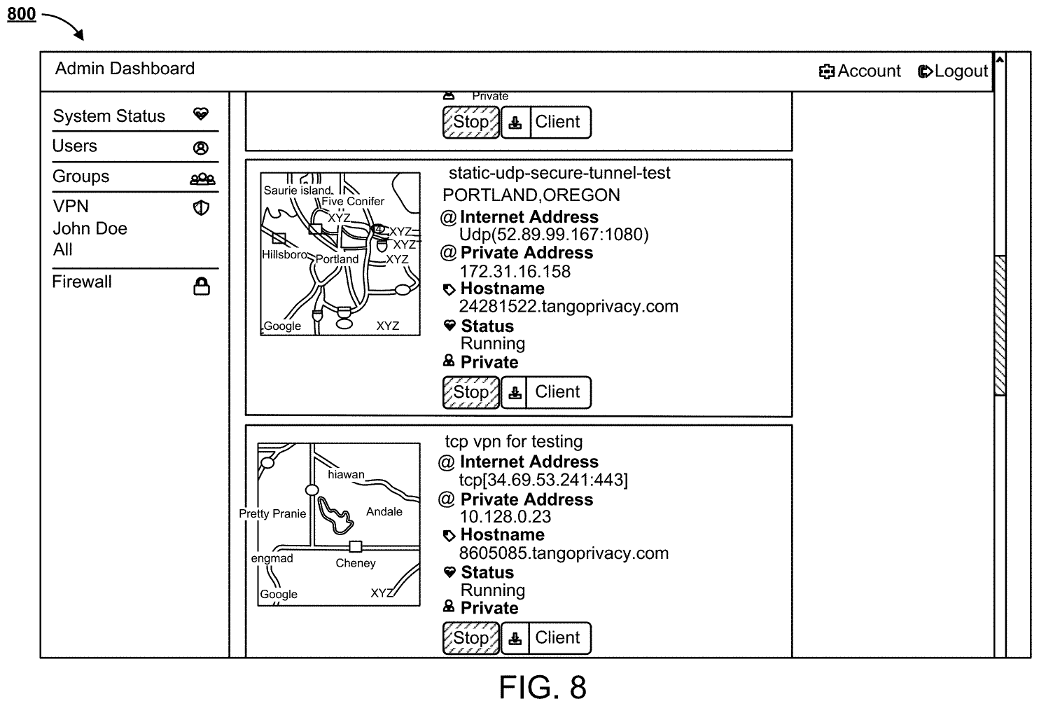

According to even another embodiment, FIG. 8 shows an administrative dashboard UI 800 displaying testing of one or more VPNs. As shown in the UI, one of the tests is performed on Static-UDP-secure-tunnel test. Another one of the tests is performed on TCP VPN for testing. The UI provides a prompt box to stop testing and to display the client.

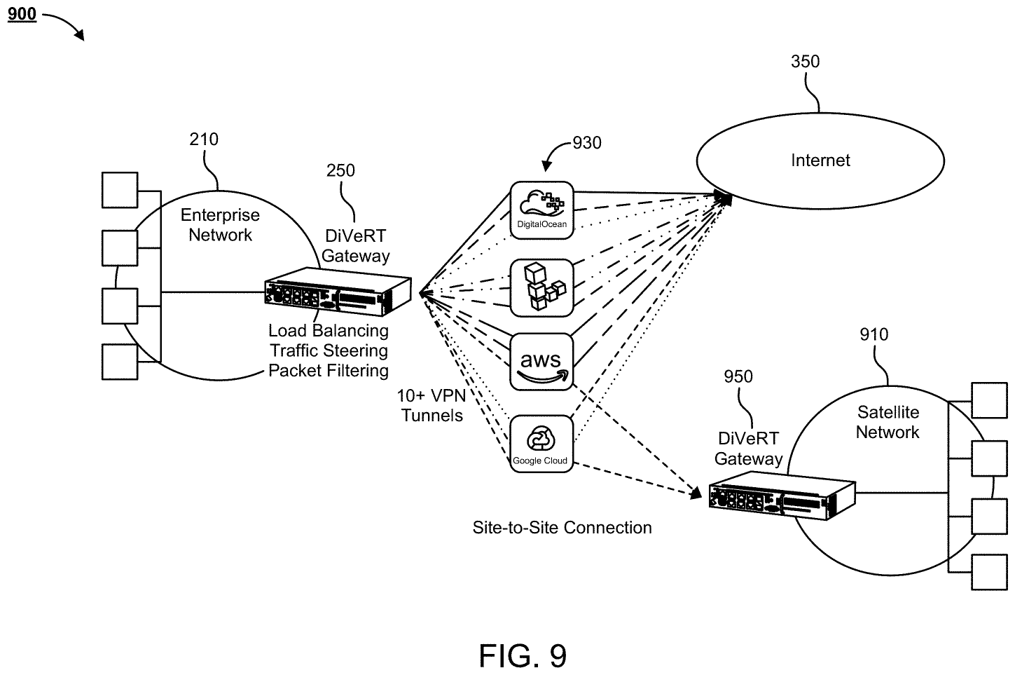

According to a further aspect of the application, the system architecture 900 of FIG. 9 illustrates plural networks are connected and in communication with one another via one or more encrypted pathways over one or more cloud servers 910. Here, at least two smart gateways 250, 950, communicate with one another. Namely, the smart gateway 250 communicates with the network 210 and performs traffic diversification and load balancing as described above in detail with regard to FIGS. 2-5A. Network traffic flows through the smart gateway 250 via one or more encrypted pathways and via one or more cloud servers. The network traffic may reach its destination via a satellite smart gateway 950 communicating with clients in a satellite network 910.

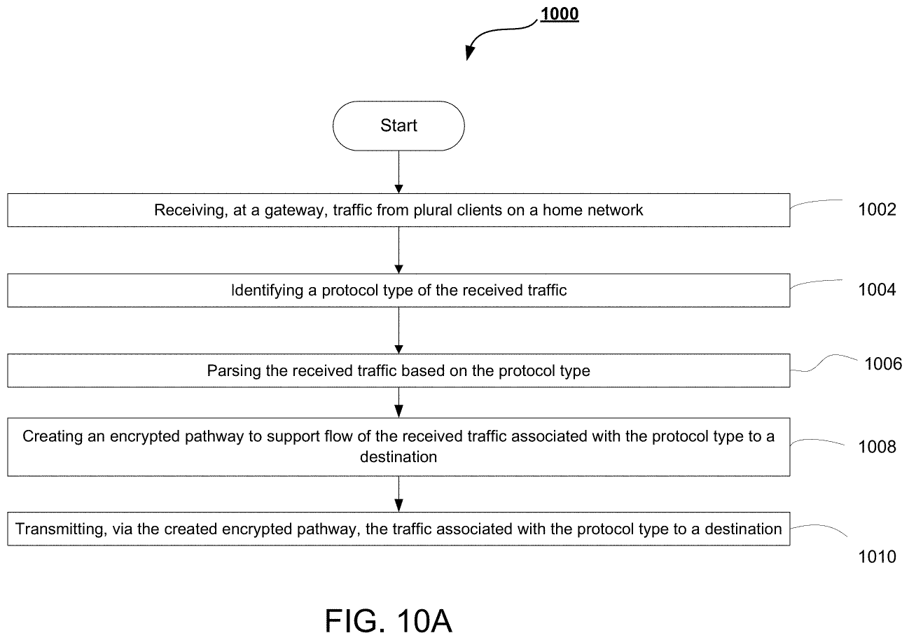

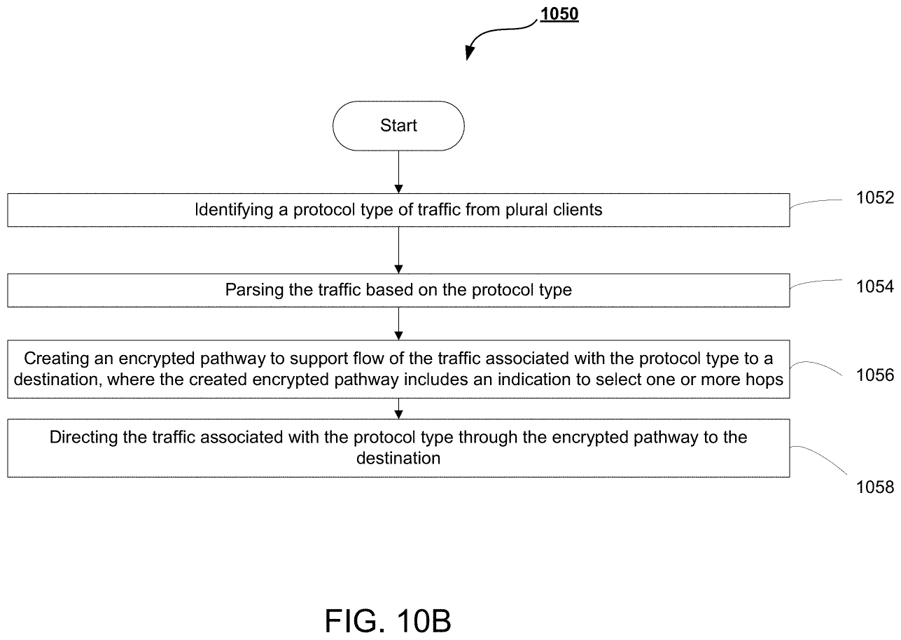

Still yet another aspect of the application describes a method or algorithm 1000 which may be deployed via a system for obfuscating traffic as illustrated in FIG. 10A. Step 1002 may include receiving, at a gateway, traffic from plural clients on a home network. Step 1004 may include identifying a protocol type of the received traffic. Step 1006 may include parsing the received traffic based on the protocol type. Step 1008 may include creating an encrypted pathway to support flow of the received traffic associated with the protocol type to a destination. Further, Step 1008 may include transmitting, via the created encrypted pathway, the traffic associated with the protocol type to a destination.

Yet even another aspect of the application describes a method or algorithm 1050 which may be deployed via a system for obfuscating traffic as illustrated in FIG. 10B. Step 1052 may include identifying a protocol type of traffic from plural clients. Step 1054 may include parsing the traffic based on the protocol type. Step 1056 may include creating an encrypted pathway to support flow of the traffic associated with the protocol type to a destination, where the created encrypted pathway includes an indication to select one or more hops. Step 1058 may include directing the traffic associated with the protocol type through the encrypted pathway to the destination.

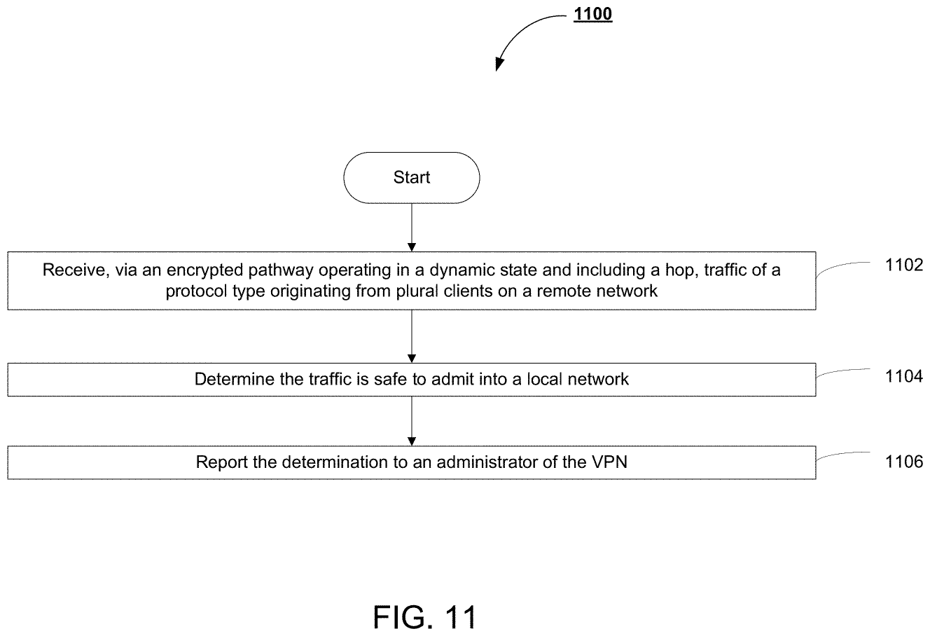

Yet even a further aspect of the application describes a method or algorithm 1100 which may which cause the following actions to occur at a gateway as illustrated in FIG. 11. Step 1102 includes identifying a protocol type of traffic from plural clients. Step 1104 includes parsing the traffic based on the protocol type. Further, Step 1106 includes creating an encrypted pathway to support flow of the traffic associated with the protocol type to a destination, where the created encrypted pathway includes an indication to select one or more hops.

### Network Obfuscation and ML Models

In even another aspect of the application, a network built for obfuscation and privacy is described. The network requires a different approach from traditional network defenses. According to this aspect, it may be desired to quickly deduce whether the network is being probed by a third party. Since probing may occur in both active and covert ways, it is important to understand who and what information is being sought about multi-hop network activity and nodes therein.

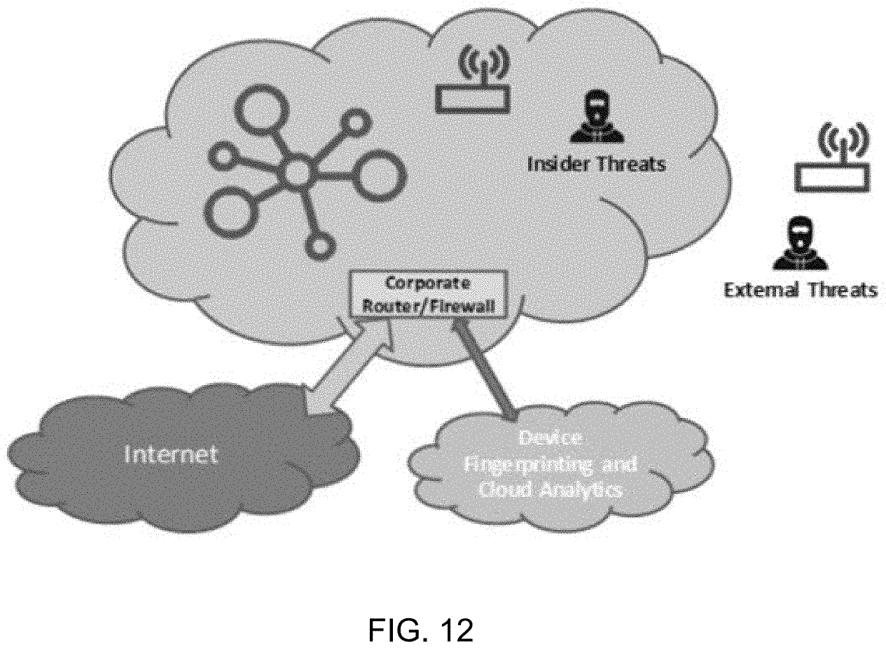

According to an embodiment, a wireless threat landscape is depicted in FIG. 12. Specifically, the threats may come from either inside or outside of the network. Outside threats may include rogue Wi-Fi (or cellular) threats. The rogue threat may occur via a man-in-the-middle (MITM) attack whereby the attacker secretly relays and possibly alters the communication between two parties who believe they are directly communicating with each other. One example is active eavesdropping, in which the attacker makes independent connections with the victims and relays messages between them to make them believe they are talking directly to each other over a private connection. Unfortunately, the conversation is controlled by the attacker. The attacker must be able to intercept all relevant messages passing between the two victims and inject new ones.

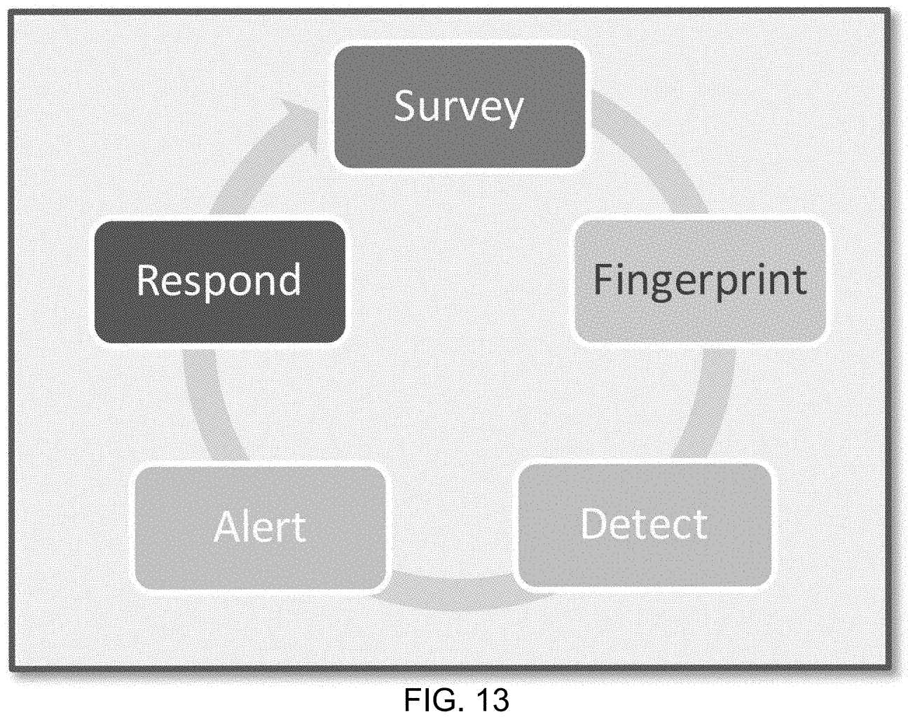

According to yet another embodiment, FIG. 13 illustrates a general flow for a detection and identification software application. Moving clockwise beginning at noon in FIG. 13, the software application persistently surveys, analyzes, and fingerprints network traffic. The system may use unsupervised or supervised ML detection algorithms to flag anomalous traffic. Upon detection, the application alerts the administrator with a variety of configurable notification options, such as push alerts to a browser. After detecting anomalous activity, the software application may respond by with appropriate mitigation techniques.

According to yet even another embodiment, heuristic and ML techniques may be employed to evaluate, determine, and flag determined probes of traffic sent by third parties to nodes/clients in the multi-hop network. The determination of the probe from the sent traffic helps a network administrator plan for securing confidential and valuable information. It is envisaged in the application that purposeful, consistent and organized interrogation of probes identified by the trained ML model may improve network security technology.

According to an exemplary embodiment, an input to train the ML model may stem from past traffic 180 received via third parties communicating with the multi-hop network. Another input to train the ML model may stem from past traffic 180 received via third parties communicating with another multi-hop network. The past traffic 180 may be evaluated for specific attributes, i.e., model parameters, indicative of a red flag. For example, identifying the same IP address sending pings or requests to the nodes on the network may be an identifying attribute. Moreover, inbound requests from VPNs and other public obfuscation networks may be an identifying attribute. Further, if the requests originate from the same privacy provider network. Even further, the source geography of the probes being similar may be an identifying attribute. That is, whether probes come from the same country or from wholly unrelated countries Yet even a further identifying attribute may be whether probes have the same cadence.

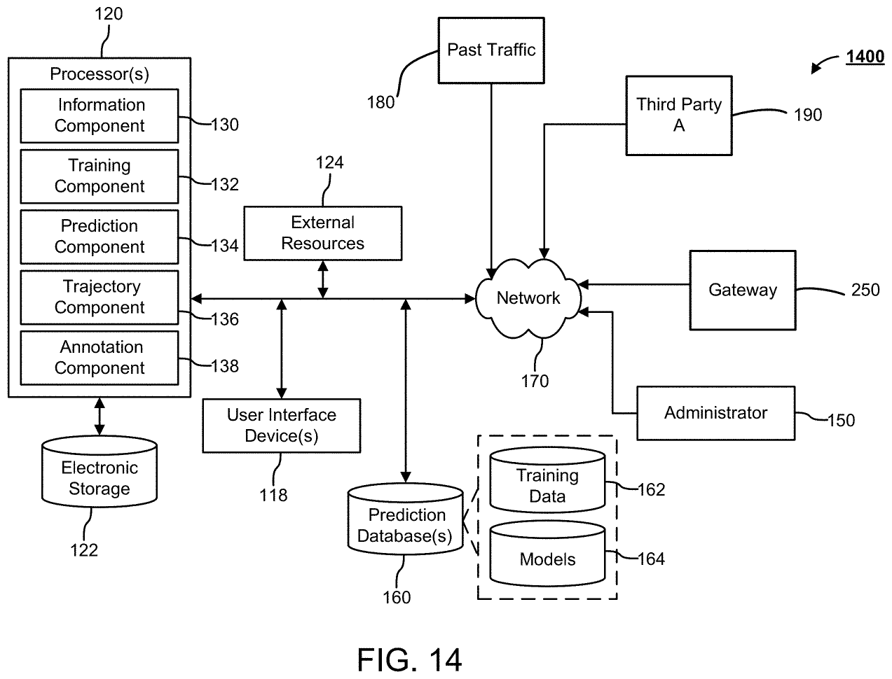

As envisaged in the application, and particularly in regard to the ML model shown in the exemplary embodiment in FIG. 14, the terms artificial neural network (ANN) and neural network (NN) may be used interchangeably. An ANN may be configured to determine a classification (e.g., type of probe) based on identified information. An ANN is a network or circuit of artificial neurons or nodes, and it may be used for predictive modeling. The prediction models may be and/or include one or more neural networks (e.g., deep neural networks, artificial neural networks, or other neural networks), other ML models, or other prediction models.

Disclosed implementations of ANNs may apply a weight and transform the input data by applying a function, where this transformation is a neural layer. The function may be linear or, more preferably, a nonlinear activation function, such as a logistic sigmoid, Tan h, or ReLU function. Intermediate outputs of one layer may be used as the input into a next layer. The neural network through repeated transformations learns multiple layers that may be combined into a final layer that makes predictions. This training (i.e., learning) may be performed by varying weights or parameters to minimize the difference between predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. In an exemplary embodiment, hyperparameters are set before learning and model parameters can be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values. Based on the results of training, the hyperparameters can be set to optimal values that provide a stable learning rate and accuracy.

A convolutional neural network (CNN) may comprise an input and an output layer, as well as multiple hidden layers. The hidden layers of a CNN typically comprise a series of convolutional layers that convolve with a multiplication or other dot product. The activation function is commonly a ReLU layer and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

In some embodiments, the learning of models 164 may be of reinforcement, supervised, semi-supervised, and/or unsupervised type. For example, there may be a model for certain predictions that is learned with one of these types but another model for other predictions may be learned with another of these types.

Supervised learning is the ML task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of ML that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data).

Semi-supervised learning makes use of supervised and unsupervised techniques described above. The supervised and unsupervised techniques may be split evenly for semi-supervised learning. Alternatively, semi-supervised learning may involve a certain percentage of supervised techniques and a remaining percentage involving unsupervised techniques.

Models 164 may analyze made predictions against a reference set of data called the validation set. In some use cases, the reference outputs resulting from the assessment of made predictions against a validation set may be provided as an input to the prediction models, which the prediction model may utilize to determine whether its predictions are accurate, to determine the level of accuracy or completeness with respect to the validation set, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 132 in the architecture 1400 illustrated in FIG. 14 may implement an algorithm for building and training one or more deep neural networks. A used model may follow this algorithm and already be trained on data. In some embodiments, training component 132 may train a deep learning model on training data 162 providing even more accuracy after successful tests with these or other algorithms are performed and after the model is provided a large enough dataset.

In an exemplary embodiment, a model implementing a neural network may be trained using training data from storage/database 162. For example, the training data obtained from prediction database 160 of FIG. 14 may comprise hundreds, thousands, or even many millions of pieces of information. The training data may also include past traffic 180 associated with the instant multi-hop network or another multi-hop network. Model parameters from the training data 162 and/or past traffic 180 may include but is not limited to: type of protocol in the traffic, source IP address, associated encrypted pathway, provider of the encrypted pathway, source geography, cadence, and content. Weights for each of the model parameters may be adjusted through training.

The training dataset may be split between training, validation, and test sets in any suitable fashion. For example, some embodiments may use about 60% or 80% of the known probes for training or validation, and the other about 40% or 20% may be used for validation or testing. In another example, training component 32 may randomly split the data, the exact ratio of training versus test data varies throughout. When a satisfactory model is found, training component 132 may train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 164 may leverage, via training component 132, an SQL server and a Pivotal Greenplum database for data storage and extraction purposes.

In some embodiments, training component 132 may be configured to obtain training data from any suitable source, e.g., via prediction database 160, electronic storage 122, external resources 124, network 170, and/or UI device(s) 118. The training data may comprise, a type of protocol, source IP address, destination IP address, source and destination port numbers, associated encrypted pathway, provider of the encrypted pathway, source geography, cadence, content, time of day, etc.).

In some embodiments, training component 132 may enable one or more prediction models to be trained. The training of the neural networks may be performed via several iterations. For each training iteration, a classification prediction (e.g., output of a layer) of the neural network(s) may be determined and compared to the corresponding, known classification. For example, sensed data known to capture a closed environment comprising dynamic and/or static objects may be input, during the training or validation, into the neural network to determine whether the prediction model may properly predict probes from third parties. As such, the neural network is configured to receive at least a portion of the training data as an input feature space. As shown in FIG. 14, once trained, the model(s) may be stored in database/storage 164 of prediction database 160 and then used to classify received probes from third parties.

Electronic storage 122 of FIG. 14 comprises electronic storage media that electronically stores information. The electronic storage media of electronic storage 122 may comprise system storage that is provided integrally (i.e., substantially non-removable) with a system and/or removable storage that is removably connectable to a system via, for example, a port (e.g., a USB port, a firewire port, etc.) or a drive (e.g., a disk drive, etc.). Electronic storage 122 may be (in whole or in part) a separate component within the system, or electronic storage 122 may be provided (in whole or in part) integrally with one or more other components of a system (e.g., a user interface (UI) device 118, processor 121, etc.). In some embodiments, electronic storage 122 may be located in a server together with processor 121, in a server that is part of external resources 124, in UI devices 118, and/or in other locations. Electronic storage 122 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 122 may store software algorithms, information obtained and/or determined by processor 121, information received via UI devices 118 and/or other external computing systems, information received from external resources 124, and/or other information that enables system to function as described herein.

External resources 124 may include sources of information (e.g., databases, websites, etc.), external entities participating with a system, one or more servers outside of a system, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 124 may be provided by other components or resources included in the system. Processor 121, external resources 124, UI device 118, electronic storage 122, a network, and/or other components of the system may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

UI device(s) 118 of the system may be configured to provide an interface between one or more clients/users and the system. The UI devices 118 may include client devices such as computers, tablets and smart devices. The UI devices 118 may also include the administrative dashboard 150 and/or smart gateway 250. UI devices 118 are configured to provide information to and/or receive information from the one or more users/clients 118. UI devices 118 include a UI and/or other components. The UI may be and/or include a graphical UI configured to present views and/or fields configured to receive entry and/or selection with respect to particular functionality of the system, and/or provide and/or receive other information. In some embodiments, the UI of UI devices 118 may include a plurality of separate interfaces associated with processors 121 and/or other components of the system. Examples of interface devices suitable for inclusion in UI device 118 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 118 include a removable storage interface. In this example, information may be loaded into UI devices 118 from removable storage (e.g., a smart card, a flash drive, a removable disk) that enables users to customize the implementation of UI devices 118.

In some embodiments, UI devices 118 are configured to provide a UI, processing capabilities, databases, and/or electronic storage to the system. As such, UI devices 118 may include processors 121, electronic storage 122, external resources 124, and/or other components of the system. In some embodiments, UI devices 118 are connected to a network (e.g., the Internet). In some embodiments, UI devices 118 do not include processor 121, electronic storage 122, external resources 124, and/or other components of system, but instead communicate with these components via dedicated lines, a bus, a switch, network, or other communication means. The communication may be wireless or wired. In some embodiments, UI devices 118 are laptops, desktop computers, smartphones, tablet computers, and/or other UI devices on the network.

Data and content may be exchanged between the various components of the system through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose, the Internet Protocol (IP) defines addressing methods and structures for datagram encapsulation. Of course, other protocols also may be used. Examples of an Internet protocol include Internet Protocol version 4 (IPv4) and Internet Protocol version 6 (IPv6).

In some embodiments, processor(s) 121 may form part (e.g., in a same or separate housing) of a user device, a consumer electronics device, a mobile phone, a smartphone, a personal data assistant, a digital tablet/pad computer, a wearable device (e.g., watch), AR goggles, VR goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 121 is configured to provide information processing capabilities in the system. Processor 121 may comprise one or more of a digital processor, an analog processor, a digital circuit designed to process information, an analog circuit designed to process information, a state machine, and/or other mechanisms for electronically processing information. Although processor 121 is shown in FIG. 14 as a single entity, this is for illustrative purposes only. In some embodiments, processor 121 may comprise a plurality of processing units. These processing units may be physically located within the same device (e.g., a server), or processor 121 may represent processing functionality of a plurality of devices operating in coordination (e.g., one or more servers, UI devices 118, devices that are part of external resources 124, electronic storage 122, and/or other devices).

As shown in FIG. 14, processor 121 is configured via machine-readable instructions to execute one or more computer program components. The computer program components may comprise one or more of information component 131, training component 132, prediction component 134, annotation component 136, trajectory component 38, and/or other components. Processor 121 may be configured to execute components 131, 132, 134, 136, and/or 138 by: software; hardware; firmware; some combination of software, hardware, and/or firmware; and/or other mechanisms for configuring processing capabilities on processor 21.

It should be appreciated that although components 131, 132, 134, 136, and 138 are illustrated in FIG. 14 as being co-located within a single processing unit, in embodiments in which processor 121 comprises multiple processing units, one or more of components 31, 132, 134, 136, and/or 138 may be located remotely from the other components. For example, in some embodiments, each of processor components 131, 132, 134, 136, and 138 may comprise a separate and distinct set of processors. The description of the functionality provided by the different components 131, 132, 134, 136, and/or 138 described below is for illustrative purposes, and is not intended to be limiting, as any of components 131, 132, 134, 136, and/or 138 may provide more or less functionality than is described. For example, one or more of components 131, 132, 134, 136, and/or 138 may be eliminated, and some or all of its functionality may be provided by other components 131, 132, 134, 136, and/or 138. As another example, processor 121 may be configured to execute one or more additional components that may perform some or all of the functionality attributed below to one of components 131, 132, 134, 136, and/or 138.

FIG. 14 also illustrates a smart gateway 250 connected to network 170. Smart gateway 250 receives traffic from one or more third parties over the network 170. For example, Third Party A (or other Third Parties) 190 may transmit traffic to the network 170. Smart gateway 250 routes and monitors received traffic and transmits it to respective clients 118 on the local network.

Concurrently, the smart gateway 250 and/or processor 120 may employ one or more of the trained ML models 164 in the predication database 160, based upon the training data 162, to evaluate new probes originating from traffic sent by Third party A 190. The new probe is flagged if it is determined the probe was intended to obtain sensitive and/or confidential information about the multi-hop network or nodes located therein. The flagged probe may appear in a database of the administrator 150. The probe may also be added to a list of marked probes in the database. Another trained ML model 164 may be used to further evaluate threat levels of the marked probes in the database.

In an exemplary embodiment upon the probe being flagged, the type of probe and the associated third party transmitter may be blocked from communicating with clients 118. In an alternative embodiment, the smart gateway 250 and processor 120 may permit further traffic from the same third party transmitting the determined probe for a specific period of time. This may be to gain additional information about the third party or to further understand the determined protocols.

In yet another embodiment, FIG. 14 illustrates an administrator 150 connected to the network 170. Administrator 150 is also operably coupled to the gateway. Administrator 150 is able to view the monitoring, flagging, and/or updating of traffic routing policies for one or more clients/UI devices 118. Moreover, the administrator 150 may be able to create, delete and rotate encrypted pathways as described above in the application.

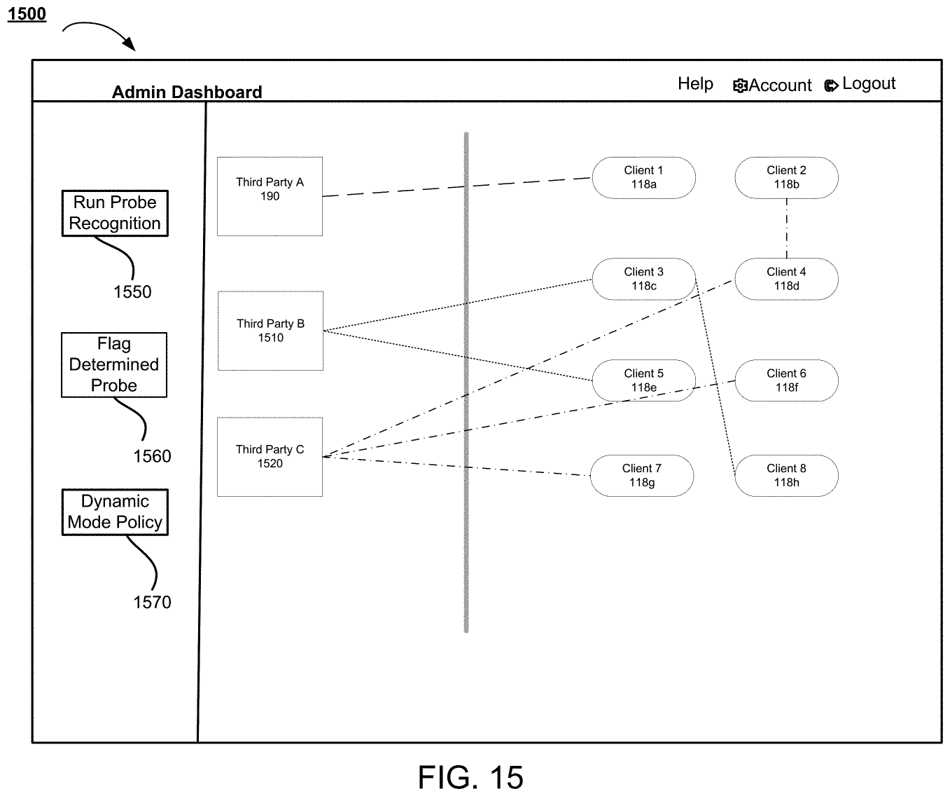

According to yet a further embodiment, FIG. 15 illustrates an administrative dashboard UI 1500 to monitor, flag and update policies for determined protocols. Namely, the administrator dashboard 1500 illustrates a snapshot of sent traffic from Third party A 190, Third party B 1510, and Third party C 1520 to one or more clients 118a-h. The administrator dashboard may include a Run Probe Recognition 1550 option which is configured to overlay determined probes originating from various third party hacker tracker run through the trained ML model. This may be run in real-time to provide a quick snapshot of threats in the multi-hop network. The traffic, and possibly a determined probe from the trained ML model, originating from each third party is represented by different lines types. For example, Third party A's 190 transmitted traffic is represented by a single dashed line to client 118a. Here, the single dashed line may be representative of traffic versus a determined probe. Traffic versus a determined probe may also be varied by color, line weights or other distinctions and is envisaged according to the instant application.

Administrator dashboard 1500 illustrates a dotted line extending from Third party B 1510 to Client 3 118c and Client 5 118e. This is caused by the Run Probe Recognition 1550 option being executed by a user. In another embodiment, the UI 1500 may also be able to depict a dotted line extending from Client 3 118c to Client 8 118h. This is understood to mean that the determined probe is attempting to inferentially gain information about Client 8 118 h through communications with Client 3 118c.

In another embodiment, when then Run Probe Recognition 1550 option is not executed, the dotted line extending from Third party B 1510 may appear as a single dashed line. The UI 1500 may be configured to show only dashed lines indicating of traffic. The UI may alternatively be configured to show only dotted lines indicative of determined probes. The UI may otherwise be configured to show both dotted and dashed lines as depicted in FIG. 15.

Further in FIG. 15, Third party C's 1520 traffic is transmitted to each of Client 4 118d, Client 6 118f and Client 7 118g. The traffic is represented by a hashed-dotted line. This is understood to mean determined probe based upon traffic run through the trained ML model. Similar to the scenario for Third party B, Third party C may also attempt to inferentially gain information about a client via another client. Here, Third party C 1520 transmits a determined probe depicted by the hashed-dotted line to Client 4 118d. The UI 1500 illustrates the determined probe inferentially gaining information about Client 2 118b.

Even further in FIG. 15, the administrator dashboard 1500 depicts an option to Flag a Determined Probe 1560. This option allows the user to add the determined probe to a flagged database. Determined probes in a flagged database may be independently monitored. For example, if the administrator wishes to continue following activity of a particular determined probe, it may be moved to the flagged database.

As even further depicted in FIG. 15, the administrator dashboard 1500 provides an option to update a Dynamic Mode Policy 1570. The Dynamic Mode Policy may be used to prevent suspected traffic of having a probe from entering the multi-hop network. The Dynamic Mode Policy may also be used to initiate traffic monitoring policies of suspected traffic meeting one more criteria. The criteria may be based on anomalies gathered from the training data and from determined probes via the trained ML model. The Dynamic Mode Policy 1570 may automatically be run after a predetermined period, e.g., daily, weekly, monthly, etc., in accordance with customized inputs and/or may manually be run by the administrator.

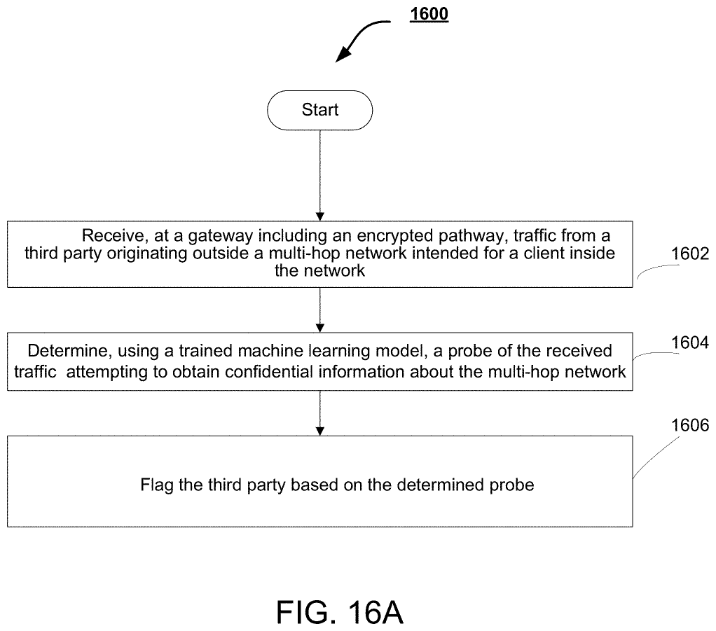

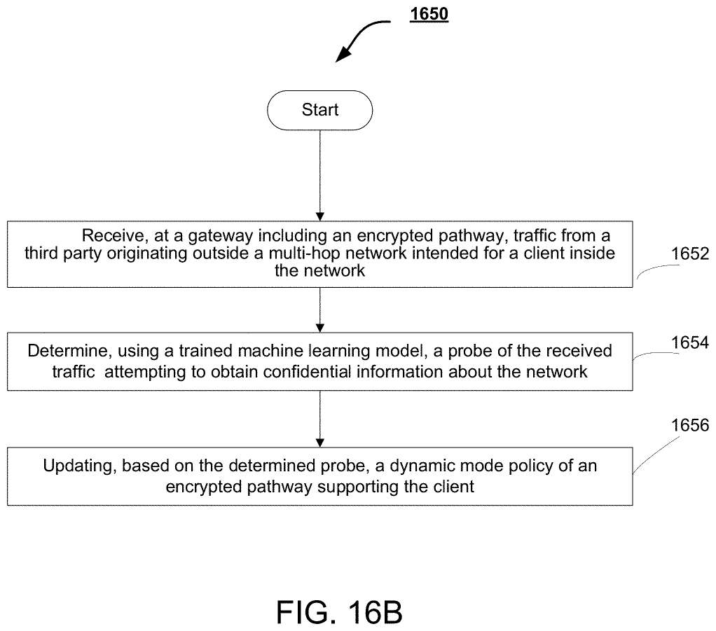

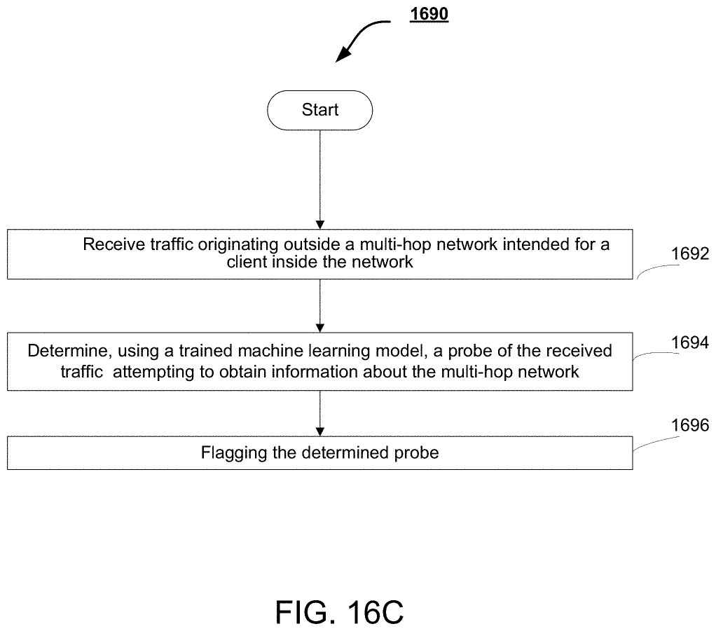

Yet another aspect of the application describes a method or algorithm 1600 which may be deployed at a system including a gateway, or alternatively deployed remotely at another server, as illustrated in FIG. 16A. Step 1602 may include receiving, at a gateway, traffic from a third party originating outside a multi-hop network including an encrypted pathway intended for a client inside the network. Step 1604 may include determining, using a trained ML model, a probe of the received traffic attempting to obtain confidential information about the multi-hop network. Step 1606 may include flagging the third party based on the determined probe.

Yet even another aspect of the application describes a method or algorithm 1650 which may be deployed at a system including a gateway, or alternatively deployed remotely at another server, as illustrated in FIG. 16B. Step 1652 may include receiving, at a gateway including an encrypted pathway, traffic from a third party originating outside a multi-hop network intended for a client inside the network. Step 1654 may include determining, via a trained ML model, a probe of the received traffic attempting to obtain information about the network. Step 1656 may include updating, based on the determined probe, a dynamic mode policy of an encrypted pathway supporting the client.

Yet even a further aspect of the application describes a method or algorithm 1690 which may be deployed at a system including a gateway, or alternatively deployed remotely at another server, as illustrated in FIG. 16C. Step 1692 may include receiving traffic originating outside a multi-hop network intended for a client inside the network. Step 1694 may include determining, using a trained ML model, a probe of the received traffic attempting to obtain information about the multi-hop network. Step 1696 may include flagging the determined probe.

### Predicting an Imminent Event at a Network

According to yet another aspect of the application, methods and systems are described to confidently predict an imminent event that may occur at a network. For example, the network may include infrastructure, whether static or mobile, in a geographic location. In an exemplary embodiment, the imminent event may include an attack to infrastructure located on a network at a particular geographic location. In another exemplary embodiment, the imminent event may be associated with a natural disaster at a particular geographic location.

In an exemplary embodiment, the infrastructure may be deployed by an occupying military in a geographic area, e.g., middle east, where a faction of the population may potentially threaten the continuing functionality of the infrastructure. The deployed infrastructure may be destroyed or require repair should an imminent event such as an attack or natural disaster occur. The instant aspect describes mechanisms to predict an imminent event using trained ML models. By so doing, traffic between a first network, e.g., Enterprise Network, and infrastructure of a second network, e.g., Satellite Network A, may be permanently or temporarily transferred to a third network, e.g., Satellite Network B.

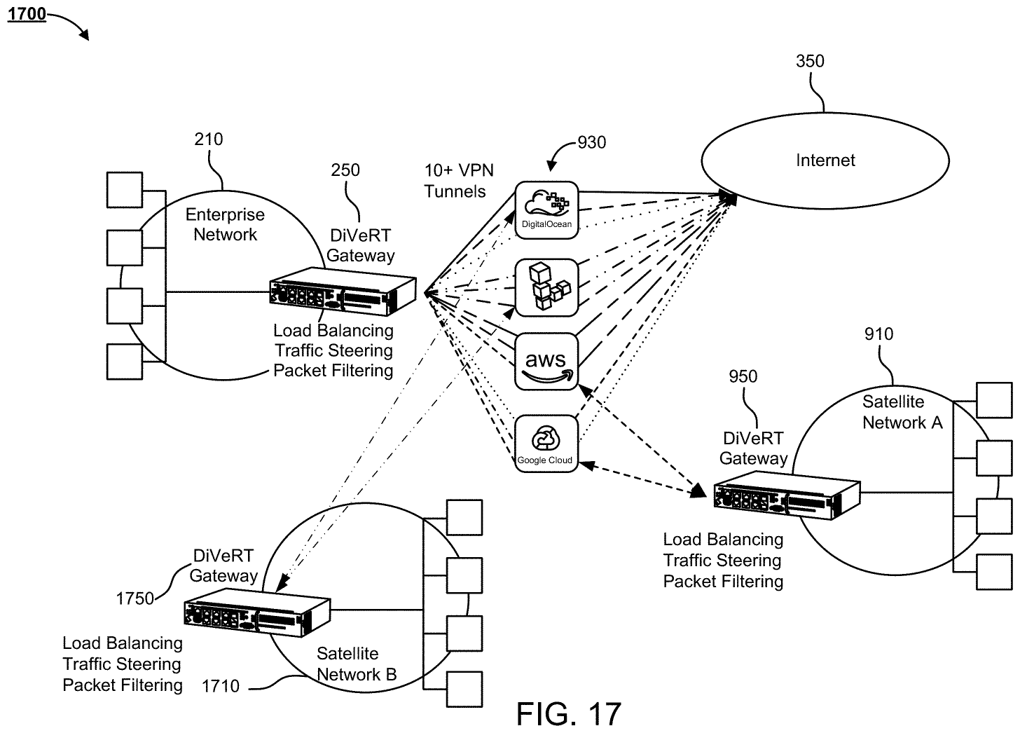

According to an embodiment as exemplarily illustrated in the architecture 1700 portrayed in FIG. 17, an enterprise network 210 transmits traffic to, and receives traffic from, satellite network 910 over one or more encrypted pathways. According to an embodiment of this aspect, enterprise network 210 or satellite network 910 may learn of an imminent event about to occur at satellite network 910 (or possibly the enterprise network 210). The imminent event may impact physical infrastructure at satellite network A 910 (or enterprise network 210). The physical infrastructure may include a node, such as for example, gateway 950 (or gateway 250).

FIG. 17 further illustrates plural dotted-hashed lines indicative of bi-directional communication and transmission of traffic between Satellite Network B 1710 (or gateway 1750) and Satellite Network A 910 (or gateway 950) over one or more encrypted pathways. Alternatively, the plural dotted-hashed lines may be representative of bi-directional communication and transmission of traffic among Satellite Network B 1710 (or gateway 1750), Satellite Network A 910 (or gateway 950) and/or Enterprise Network A 210 (or gateway 250) over one or more encrypted pathways.

Upon determining that an imminent event may potentially occur with a degree of confidence, an administrator (user or computer program) at either enterprise network 210 or satellite network A 910 may contact an administrator (user or computer program) of satellite network B 1710. A request may be made to the administrator of satellite network B 1710 for traffic to be transferred in view of the determined imminent event. The administrator of satellite network B 1710 may automatically send a reply to the transfer request. The reply may be based upon one or more predetermined protocols. For example, the predetermined protocols may include evaluating whether the imminent event would likely result in destruction or repair of infrastructure at Satellite Network A 910 (versus simply a request to transfer traffic for load balancing).

In another embodiment, assuming the administrator of Satellite Network B agrees to the transfer request, an administrator of one or both of the enterprise network 210 or satellite network A 910 may coordinate therewith. Coordination may include transferring credentials associated with the traffic, particularly for confidential information. Coordination may also include information of the VPN tunnels and number of hops being used. Coordination may further include information of the cloud servers being used.

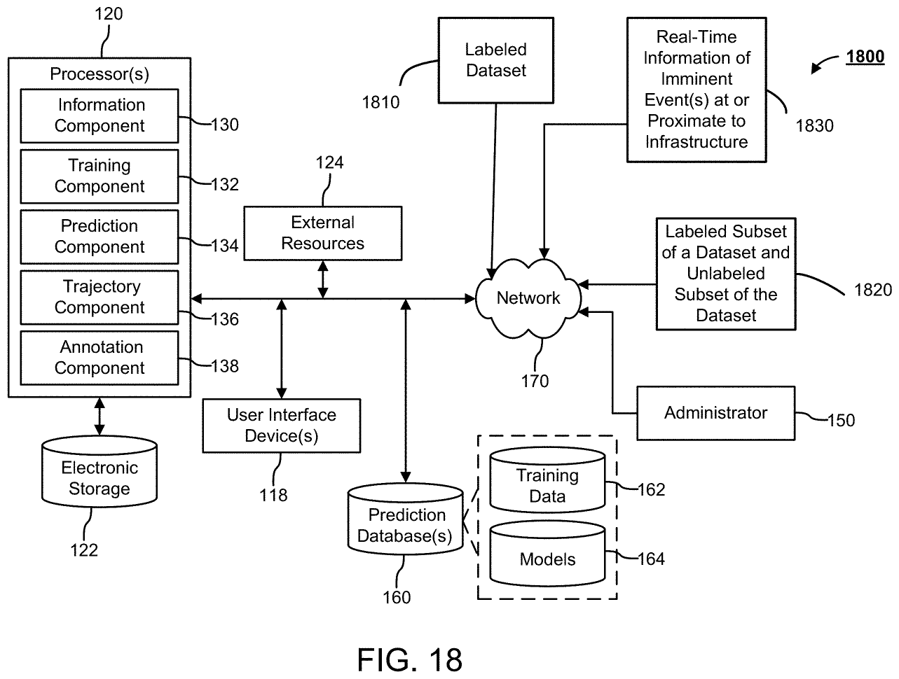

According to a further embodiment, a detailed discussion of the ML model(s) used to determine the imminent event likely to occur at Satellite Network A is described in reference to FIG. 18. Some reference indicators shown in FIG. 18 may have been previously described above in view of FIG. 14 and preserve the same nomenclature for consistency.

In this embodiment, one or more trained ML models may be located at the enterprise network, satellite network(s), or at a remote cloud server(s). In an embodiment, the ML model(s) 164 may already be trained. In another embodiment, the ML model(s) 164 may need to be trained prior to performing a determination (or retrained in view of new training data). Here, training component 132 may implement an algorithm for building and training one or more deep neural networks of the model 164. The model 164 may be trained using training data 162. For example, the training data 162 may be obtained from prediction database 160 and comprise hundreds, thousands, or even many millions of pieces of information.

According to an embodiment, the prediction database(s) 160 may obtain an entirely labeled dataset 1810 (or labeled subset 1820). The labeled dataset 1810 may be used as training data 162 to train a model 164. Once the model 164 is trained and confident to examine unlabeled real-time data 1830, the model 160 is ready to be deployed to determine an imminent event(s). The labeled dataset 1810 may be received from a data seller/licensor, data labeler and/or an administrator 150 on the current or another network.

The labeled dataset 1810 or labeled subset 1820 may be indicative of an imminent event at or near the infrastructure in the region of interest. In an embodiment, the labeled dataset 1810 or labeled subset 1820, e.g., first subset, as well one or more further unlabeled subsets of a larger dataset, may include audio, video or text pertaining to the imminent event at or proximate to the infrastructure of the satellite network. For example, the data associated with an attack may include an alert from the United Nations, the national and local governments, and/or military or civilian enforcement units. The data may also include news from international, national and/or local broadcasting sources (radio, print or digital) in the region of interest. The data may also include news received via RF or satellite communications. This data may include alerts received over secure channels potentially listening to groups considered to be a threat to the infrastructure in the region of interest.

In an alternative embodiment, the data associated with a natural disaster may include an alert from an international or national weather service. The alert may also come from a geological team. The data may also include an official notification from a nation or military. The data may also include a reporting from residents in the surrounding region.

According to an embodiment, labeling of unlabeled subsets of an obtained larger dataset may be performed by one or more ML model(s) 164 in view of the obtained labeled subset 1820. The labeled subset 1820 may be obtained from the environment, data seller/licensor, data labeler and/or an administrator 150 on the current or another network. More specifically, the prediction database(s) 160 may employ the labeled subset 1820 to train one or more of the ML model(s) 164 in order to develop robust training data 162. Training of the ML model 164 may last until the ML model 164 has a certain level of confidence based on what it has learned so far in view of a labeled subset 1820. The ML model 164 then evaluates and automatically applies labels to the unlabeled subset(s). If the ML model 164 feels that a specific datum of the unlabeled subset does not meet a certain confidence threshold, the ML model 164 transmits the specific datum to a repository or another node. The datum may be labeled by another model, or manually by a user, in view of the labelled subset 1820. Once the datum has been labelled, it may be transmitted back to the ML model 164. The ML model 164 may learn from the labeled data and improves its ability to automatically label the remaining unlabeled subset of data. Training data 162 may be generated in view of the labeled dataset.

As further shown in FIG. 18, the training data 162 may be transmitted to one or more other models 164. These models 164 learn from the labels until it has a certain degree of confidence to apply against real-time information of imminent events at or proximate to infrastructure 1830 at a network.

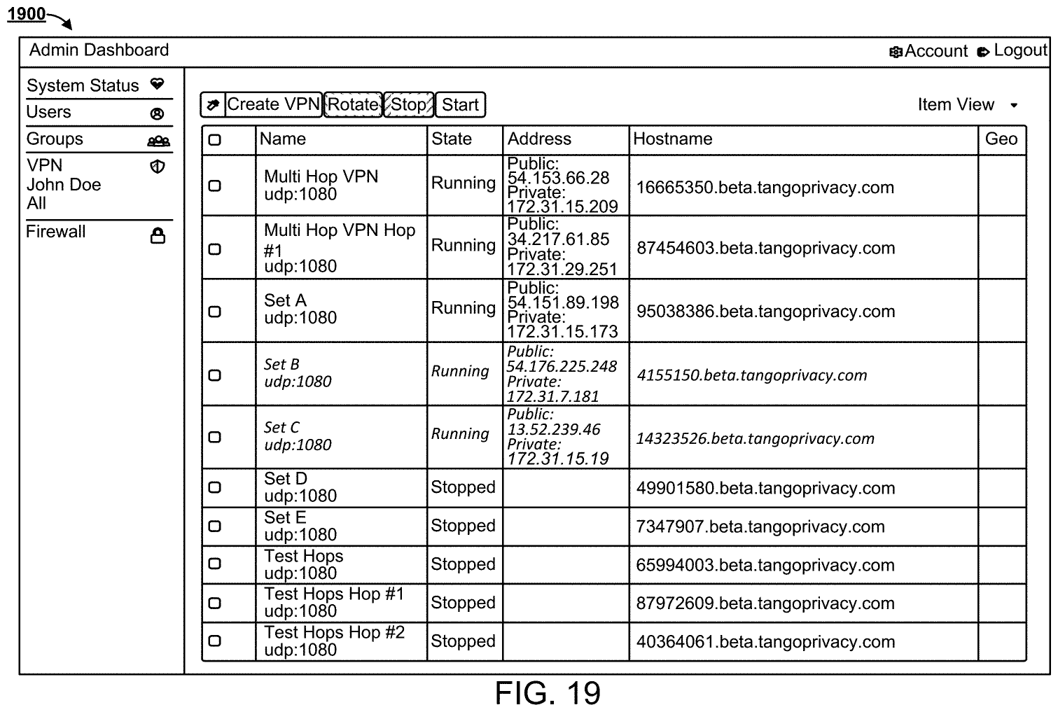

According to another aspect of the application, as exemplarily shown in FIG. 19, GUI 1900 displays an Admin Dashboard managing traffic flowing through satellite network B 1710 (or gateway 1750). As shown, rows 1-3 (non-italicized) of the Admin Dashboard shows existing traffic of satellite network B. Rows 4-5 of the Admin Dashboard show the transferred traffic streams from Satellite Network B upon the traffic transfer request. The transferred traffic streams in Rows 4-5 are depicted in italics though may be displayed in any font, color or style that allows an operator to quickly ascertain original sources of traffic for data management, computation and downstream load balancing.

According to another embodiment, one or more other trained ML model(s) 164 may be employed to determine when the imminent threat at or proximate to the infrastructure has passed. In other words, a time when it is safe to consider redirecting transferred traffic residing at satellite network B to satellite network A. One or more ML model(s) 164 (first ML model) may be trained via another labeled dataset. Alternatively, one or more other ML models 164 (second ML model) may be employed to label an unlabeled dataset based upon a labeled subset to develop training data 162. The training data 162 may be used to train the first ML model to learn and develop a degree of confidence in accordance with a configured learning rate before being deployed to evaluate a real-time imminent threat at or proximate to the infrastructure.

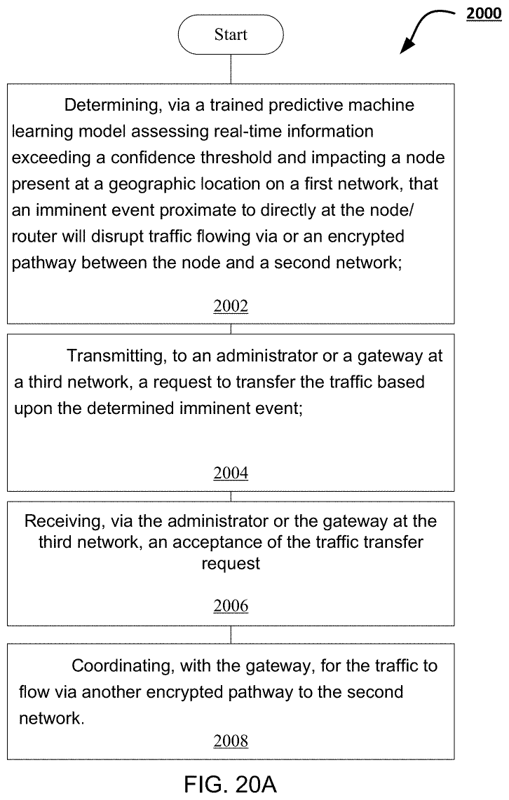

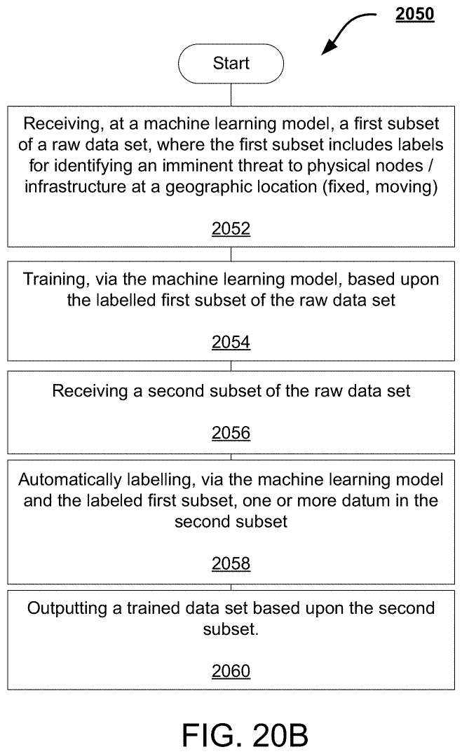

According to yet another embodiment, a method is provided as exemplarily shown in the flowchart of FIG. 20A. The method 2000 may include a step of determining, via a trained predictive ML model assessing real-time information exceeding a confidence threshold and impacting a node present at a geographic location on a first network, that an imminent event proximate to directly at the node/router will disrupt traffic flowing via or an encrypted pathway between the node and a second network (Step 2002). The method 2000 may also include a step of transmitting, to an administrator or a gateway at a third network, a request to transfer the traffic based upon the determined imminent event (Step 2004). The method 2000 may even also include a step of receiving, via the administrator or the gateway at the third network, an acceptance of the traffic transfer request (Step 2006). The method 2000 may further include a step of coordinating, with the gateway, for the traffic to flow via another encrypted pathway to the second network (Step 2008).

According to yet even another embodiment, a method is provided as exemplarily shown in the flowchart of FIG. 20B. The method 2050 may include a step of receiving, at a ML model, a first subset of a raw data set, where the first subset includes labels for identifying an imminent threat to infrastructure at a geographic location (Step 2052). In an embodiment, the infrastructure is fixed. In another embodiment, the infrastructure is mobile. The method 2050 may include a step of training, via the ML model, based upon the labelled first subset of the raw data set (Step 2054). The method 2050 may also include a step of receiving a second subset of the raw data set (2056). The method 2050 may further include a step of automatically labeling, via the ML model and the labeled first subset, one or more datum in the second subset (2058). The method 2050 may even further include a step of outputting a trained data set based upon the second subset (2060).

### Evaluating Attributes of Probes to Prevent Security Threats to a Network

According to yet even another aspect of the application, methods and systems are described that confidently evaluate attributes of one or more probes entering a network. Methods and systems also are described where the evaluation of probe attributes are employed to secure the network from potential threats arising from subsequent probes.

Probes are typically written by third parties, e.g., hackers, seeking to discover information and/or vulnerabilities in a networked system. Upon a vulnerable device being located, the probe may seek to infect it with malware. Third parties controlling these probes may subsequently gain access to the network via this vulnerable device. Moreover, third parties may scan the network from the inside to locate additional vulnerable devices to infect and control.

While not exhaustive, attributes of these probes may exemplarily include a duration of scanning (e.g., port scan or ping sweep), entry protocol, exit protocol, information desired, information obtained, type of known and unknown vulnerabilities sought in the software and hardware in the network, and type of malware to employ in the network. In an embodiment, the information desired and information obtained may include one or more of vulnerabilities in the devices and network. In another embodiment, the information desired and information obtained may include intelligence governing the network's detection, assessment and/or remediation protocols for probes.

According to an embodiment of this aspect, one or more honeypots may be employed at the home and/or satellite network. One of the purposes of the honeypot is to perform reconnaissance and gather additional data about a probe. Generally, a honeypot may be a computer system configured to run applications and/or manage real or fake data. The honeypot generally is indistinguishable from a legitimate target. However, the honeypot includes one or more vulnerabilities intentionally planted by a network administrator. Honeypots may include a bug tap to track a probe's activities. Honeypots may also be highly-interactive causing the probe to spend much time probing plural services. Honeypots may also be minimally-interactive with few services to probe than a highly-interactive honeypot.

In another embodiment, a network administrator may evaluate how a probe accessing the home or satellite network via an encrypted pathway interacts with the hardware and/or software associated with the honeypot. For example, the network administrator may employ artificial intelligence to expose characteristics and tendencies of the probe as it moves, interacts and possibly infects devices and applications in the network. In so doing, the network and network administrator may gain threat intelligence and be better equipped at predicting future attack patterns and construct appropriate countermeasures. The network administrator may also be able to confuse and deflect hackers from higher value targets residing in other locations on the network.

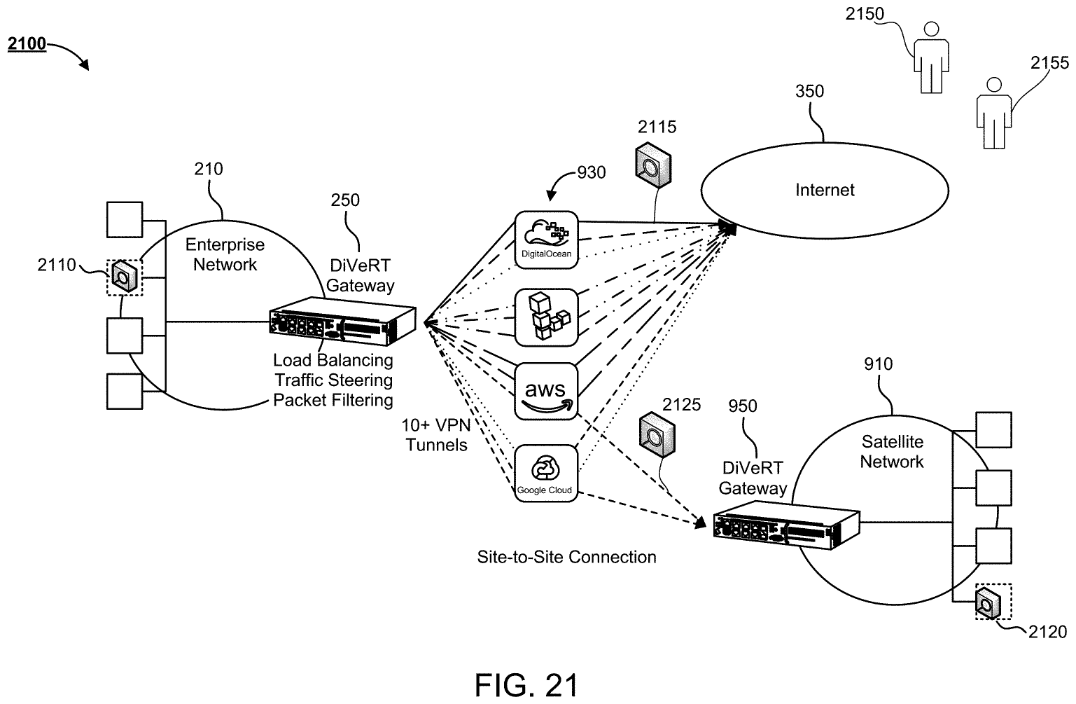

According to an embodiment as exemplarily illustrated in the architecture 2100 in FIG. 21, an enterprise network 210 transmits traffic to, and receives traffic from, one or more of a satellite network 910 and a third party 2150 (or 2155) via the Internet 350 over one or more encrypted pathways. The home network 210 or satellite network 910 may perform monitoring, detecting, evaluating and mitigation protocols associated with probe(s) entering their respective networks.

As depicted in FIG. 21, honeypot 2110 may reside at one or more nodes on the home network 210. The node may be on a computing system in one embodiment. A probe 2115 may be transmitted to the home network 210 by third party 2150 or 2155 over the encrypted pathway 930. The probe 2115, along with other traffic, may be steered by gateway 250 to one or more nodes. Probe 2115 may navigate toward, and subsequently to, honeypot 2110. Probe 2115 may perform probing and discover one or more vulnerabilities.

Real-time feedback based on the interaction between probe 2115 and honeypot 2110 may be obtained by network 210. The interaction may include probe 2115 obtaining information involving honeypot 2110. As will be discussed below in more detail, a trained predictive machine learning model may determine whether the interaction exceeds a confidence threshold. The confidence threshold may be associated with a threat level of probe 2115 to the node housing honeypot 2110 on the enterprise network 210. Alternatively, the confidence threshold may be associated with a threat level of probe 2115 the whole home/enterprise network 210. The threat level may include varying levels, such as for example, low level, medium level medium-high level, and high level. The confidence threshold maybe set by a network administrator and/or may be updated by a machine learning algorithm.

According to another embodiment, similar with honeypot 2110, FIG. 21 depicts satellite/remote network 910 having a honeypot 2120 located on a node. Probe 2125 may be transmitted by third party 2150/2155 toward satellite network 910 to obtain information or spread infection. The probe may be referred to as a malicious probe in some instances.

In an alternative embodiment, probe 2125 originating at the satellite network 910 may be transmitted to the enterprise network 210. One or more probes may also originate at the enterprise network 210 and be transmitted to the satellite network 910. Similar determinations as described above regarding exceeding a confidence threshold are equally employed here.

After the interaction with the probe has been flagged for exceeding a confidence threshold indicating a threat level, the probe, e.g., 2115 and/or 2125, and one or more attributes may be tagged. Tagging of probes may be performed according to generally known practices in the cyber security industry. Specifically, attributes may include though not limited to duration, entry protocol, exit protocol, information sought, and virus transmission.

Subsequently, the tagged probe may be transmitted to a network administrator. The tagged probe may be aggregated with other tagged probes to assess trends. Ultimately, the assessment may help create and modify security policies at the network for preventing probes from entering.

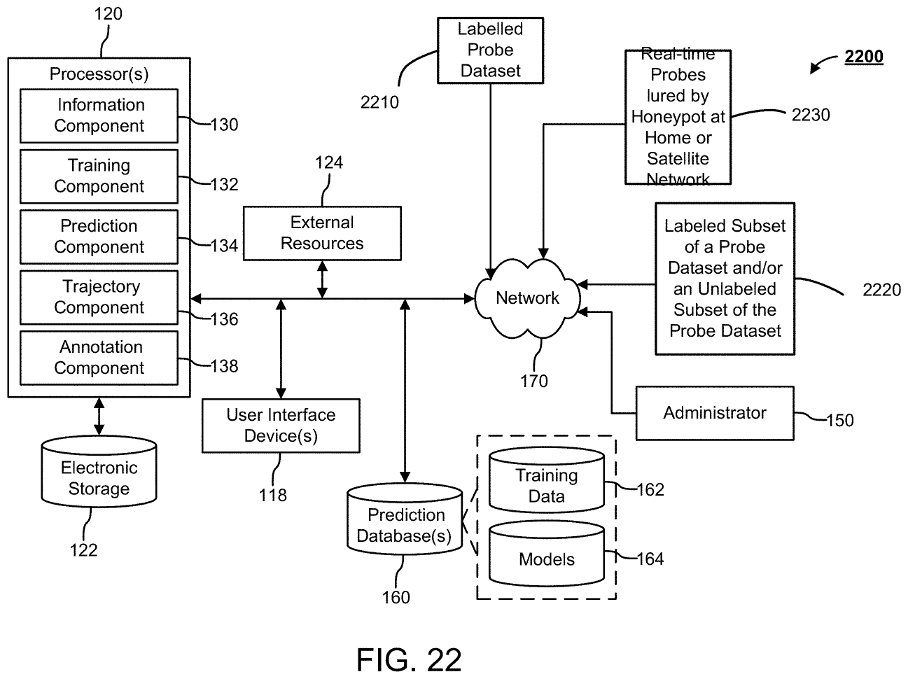

According to another embodiment, FIG. 22 exemplarily depicts one or more ML models used to develop robust training data used determine a malicious probe based upon a confidence threshold being exceeded. The developed robust training data and/or other training data may subsequently be used to train one or more or more ML models. One or more trained ML models may be used to detect malicious probes. A classification of malicious probes may be used by the network to secure the network from future intruders. In reference to FIG. 22, any reference indicators previously recited in earlier figures shall preserve the same nomenclature for consistency and clarity.

In this embodiment, one or more trained ML models may be located at the enterprise network, satellite network(s), or at a remote cloud server(s). In an embodiment, the ML model(s) 164 may already be trained. In another embodiment, the ML model(s) 164 may need to be trained prior to performing a determination (or retrained in view of new training data). Here, training component 132 may implement an algorithm for building and training one or more deep neural networks of the model 164. The model 164 may be trained using training data 162. For example, the training data 162 may be obtained from prediction database 160 and comprise hundreds, thousands, or even many millions of pieces of information.

According to an embodiment, the prediction database(s) 160 may obtain an entirely labeled probe dataset 2210. The labeled dataset 2210 may be received from a data seller/licensor, data labeler and/or an administrator 150 on the current or another network. In this instance, the model may be entirely trained from the labeled probe dataset 2210.

In another embodiment, the prediction database(s) 160 may obtain a labeled subset of the probe dataset and/or an unlabeled subset of the probe dataset (collectively 2220). More specifically, the labeled subset of the probe dataset may be used by model 164 to label an unlabeled subset of the probe dataset. Training of the ML model 164 may last until the ML model 164 has a certain level of confidence based on what it has learned so far in view of a labeled subset 2220. The ML model 164 then evaluates and automatically applies labels to the unlabeled subset(s). If the ML model 164 feels that a specific datum of the unlabeled subset does not meet a certain confidence threshold, the ML model 164 transmits the specific datum to a repository or another node. The datum may be labeled by another model, or manually by a user, in view of the labelled subset 2220. Once the datum has been labelled, it may be transmitted back to the ML model 164. The ML model 164 may learn from the labeled data and improves its ability to automatically label the remaining unlabeled subset of data. Robust training data 162 may be generated in view of the labeled dataset.

Once the model 164 is sufficiently trained to a predetermined confidence level, model 164 may be deployed to assess unlabeled, real-time probes lured by the honeypot (2230) residing at either the home or satellite network. That is, the model 160 may determine security threats posed by subsequent probes characterized as malicious probes.

As discussed earlier, the probe(s) may be transmitted by a third party located outside the network to the home or satellite network via an encrypted pathway, e.g., VPN. Alternatively, the probe(s) may be transmitted by a user/node in the home (or satellite) network (e.g., shared network) over the encrypted pathway to the satellite (or home) network.

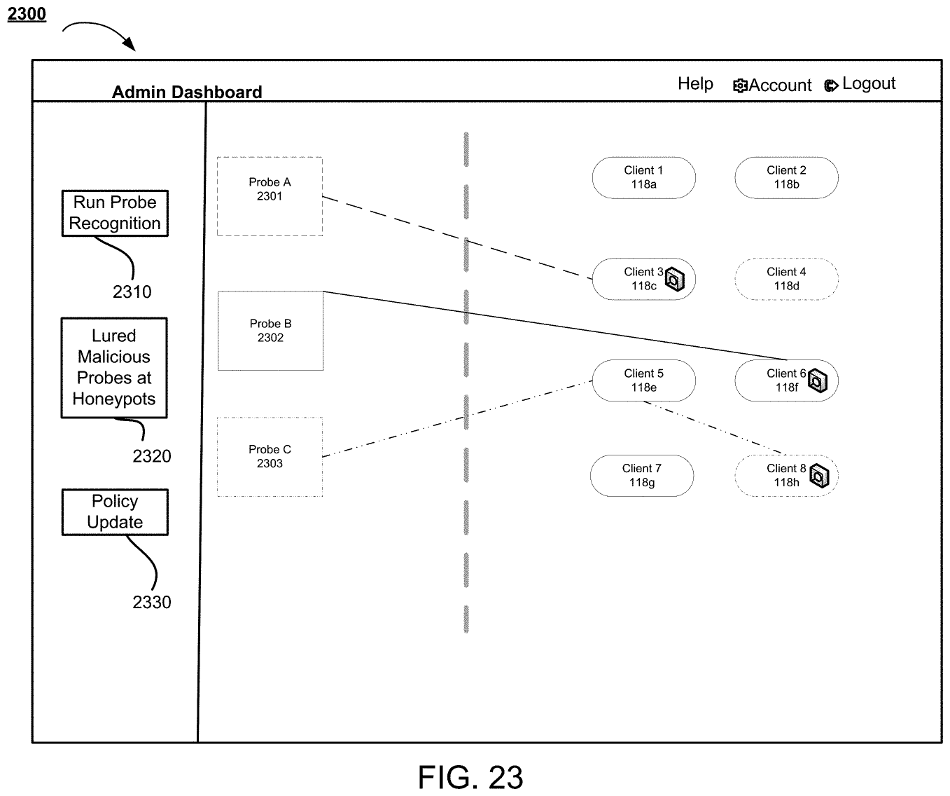

According to another aspect of the application, as exemplarily shown in FIG. 23, GUI 2300 displays an Admin Dashboard user interface displaying and managing a presence of probes 2301, 2302 and 2303 in the shared network. The Admin Dashboard may include various protocols that may be run to evaluate threats on the shared network. For example, there is a “Run Probe Recognition” 2310 that may help locate probes currently existing in the shared network. When this option is run, plural probes may be identified in the shared network. Here, for example, three probes—Probe A 2301, Probe B 2302, and Probe C 2303—may be detected.

The Admin Dashboard may also include an option to run “Lured Probes at Honeypots” 2320. When this option is run, malicious probes may appear in the UI (versus all probes in the shared network). Here, for example, malicious probes may be identified by a dashed, dotted and/or hashed line. That is, Probes A and C are identified as being malicious probes according to a determination of them exceeding a confidence threshold. Meanwhile, Probe B may not be considered malicious and identified by a solid line based on a determination of not exceeding a confidence threshold.

In an embodiment, the Admin Dashboard 2300 may depict only malicious or non-malicious probes. Alternatively, the Admin Dashboard 2300 may depict all probe types.

Admin Dashboard 2300 may also depict which honeypots the probes are currently communicating with or previously communicated with. For example, Probe A 2301 is shown communicating with a honeypot located at Client 3 118c. Meanwhile, probe C 2303 is shown communicating with a honeypot located at Client 8 118h.

According to a further embodiment, Admin Dashboard 2300 may illustrate all clients which have communicated with a probe. For example, Probe C 2303 is shown as communicating with plural clients. Namely, Probe C 2303 communicated with Client 5 118e ahead of locating the honeypot at Client 8 118h.

In even a further embodiment, Admin Dashboard 2300 may include a prompt to manually run a “Policy Update” 2330. This prompt allows the system to update its policies to more accurately detect malicious probes posing security risks to the network.

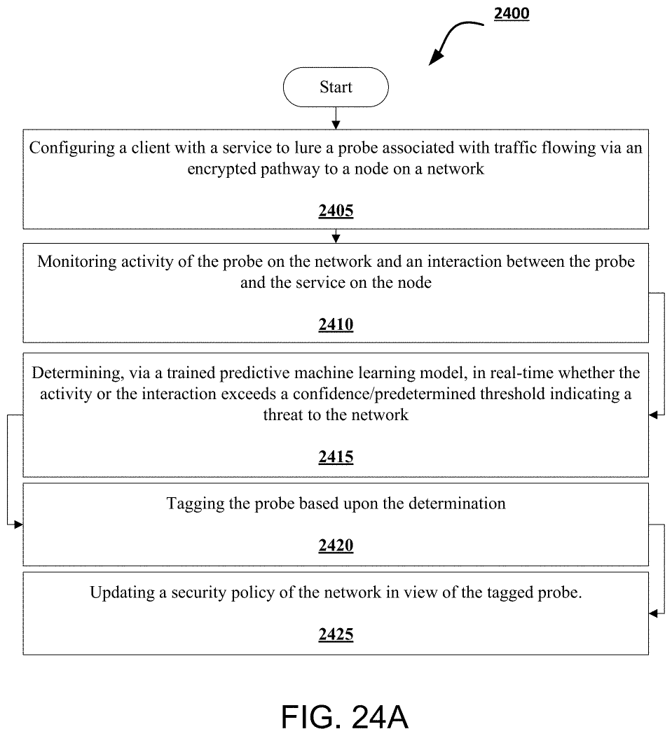

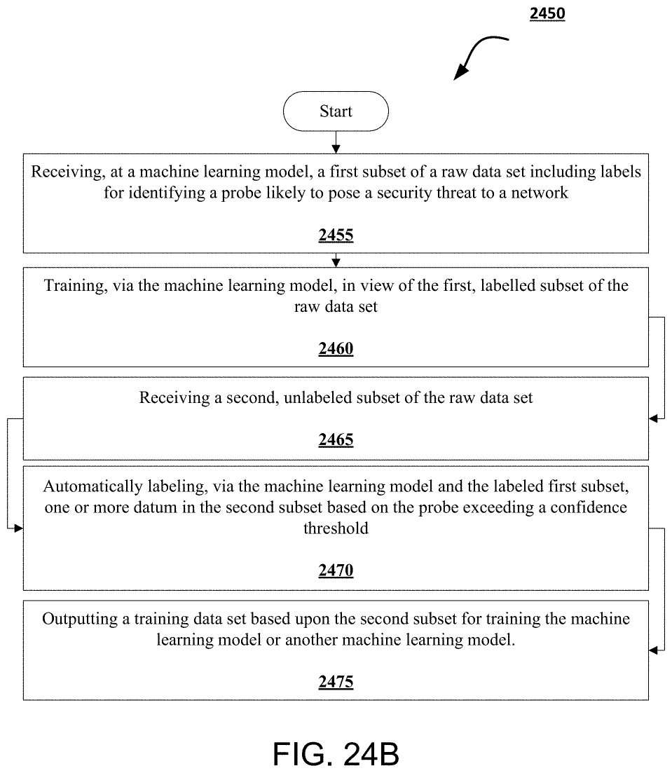

According to yet another embodiment, a method is provided as exemplarily shown in the flowchart of FIG. 24A. The method 2400 may be directed to evaluating a probe entering a network. One step of the method may include configuring a client with a service to lure a probe associated with traffic flowing via an encrypted pathway to a node on a network (Step 2405). Another one of the steps may include monitoring activity of the probe on the network and an interaction between the probe and the service on the node (Step 2410). Yet another one of the steps may include determining, via a trained predictive machine learning model, in real-time whether the activity or the interaction exceeds a confidence/predetermined threshold indicating a threat to the network (Step 2415). A further one of the steps may include tagging the probe based upon the determination (Step 2420). Even a further one of the steps may include updating a security policy of the network in view of the tagged probe (Step 2425)

According to yet even another embodiment, a method is provided as exemplarily shown in the flowchart of FIG. 24B. The method 2450 may include a step of receiving, at a machine learning model, a first subset of a raw data set including labels for identifying a probe likely to pose a security threat to a network (Step 2455). Another one of the steps may include training, via the machine learning model, in view of the first, labelled subset of the raw data set (Step 2460). Yet another one of the steps may include receiving a second, unlabeled subset of the raw data set (Step 2465). A further one of the steps may include automatically labeling, via the machine learning model and the labeled first subset, one or more datum in the second subset based on the probe exceeding a confidence threshold (Step 2470). Yet even a further one of the steps may include outputting a training data set based upon the second subset for training the machine learning model or another machine learning model (Step 2475).

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
configuring a client with a service to lure a probe associated with traffic flowing via an encrypted pathway to a node on a network;
monitoring activity of the probe on the network and an interaction between the probe and the service on the node;
determining, via a trained predictive machine learning model, in real-time whether the activity or the interaction exceeds a confidence/predetermined threshold indicating a threat to the network;
tagging the probe based upon the determination; and
updating a security policy of the network in view of the tagged probe.

2. The method of claim 1, further comprising:
predicting, based upon the updated security policy, a likelihood of another probe threatening security on the network.

3. The method of claim 1, wherein the activity or the interaction is based on one more of duration, entry protocol, exit protocol, information sought, and virus transmission.

4. The method of claim 1, wherein the probe is received from a source located outside of the network.

5. The method of claim 1, further comprising:
obtaining training data from previous traffic on the network or traffic from a third party; and
training the machine learning model with the obtained training data prior to the determination.

6. The method of claim 1, further comprising:
causing to display, via a graphical user interface, a representation of one or more tagged probes, wherein one of the tagged probes is a determined threat to the network.

7. The method of claim 1, wherein the encrypted pathway includes a security network protocol selected from the group consisting of VPN, Tor, SSH, IPSec, Passthrough and combinations thereof.

8. The method of claim 1, wherein the encrypted pathway includes plural encrypted pathways support the traffic.

9. The method of claim 8, wherein at least two of the plural encrypted pathways employs a different security network protocol.

10. The method of claim 1, wherein the encrypted pathway includes an indication for one or more hops, where each hop employs one or more of a different security network protocol, geography, cloud provider and rotation period.

11. A system comprising:
a non-transitory memory including a set of instructions; and
a processor operably coupled to the non-transitory memory configured to execute the set of instructions including:
configuring a client with a service to lure a probe associated with traffic flowing via an encrypted pathway to the client on a network;
monitoring an interaction between the probe and the service;
determining, via a trained predictive machine learning model, in real-time whether the interaction exceeds a confidence threshold indicating a threat to the network;
tagging the probe based upon the determination; and
predicting, based on the tagged probe, a likelihood of another probe threatening security on the network.

12. The system of claim 11, wherein the monitoring and determining steps include an activity of the probe on the network.

13. The system of claim 11, wherein the interaction is based on one more of duration, entry protocol, exit protocol, information sought, and virus transmission.

14. The system of claim 11, wherein the processor is further configured to execute the instructions of:
causing to display, via a graphical user interface, a representation of one or more tagged probes, wherein one of the tagged probes is a determined threat to the network.

15. The system of claim 11, wherein the probe is received from a source located outside of the network via an encrypted pathway.

16. A method comprising:
receiving, at a machine learning model, a first subset of a raw data set including labels for identifying a probe likely to pose a security threat to a network;
training, via the machine learning model, in view of the first, labelled subset of the raw data set;
receiving a second, unlabeled subset of the raw data set;
automatically labeling, via the machine learning model and the first, labeled subset, one or more datum in the second subset based on the probe exceeding a confidence threshold; and
outputting a training data set based upon the second subset for training the machine learning model or another machine learning model.

17. The method of claim 16, further comprising:
determining another datum in the second subset fails to meet a confidence threshold of the machine learning model; and
sending the another datum to an administrator for assessment.

18. The method of claim 17, further comprising:
receiving, from the administrator, the another datum in a labeled state; and
performing additional training of the machine learning model in view of the another datum in a labeled state.

19. The method of claim 18, further comprising:
transmitting a trained dataset to an administrator or to another machine learning model in view of the additional training.

20. The method of claim 16, wherein the probe is received via an encrypted pathway from a source located outside of the network.
